(19) United States
(12) Patent Application Publication
(10) Pub. No.: US 2023/0209606 A1
(43) Pub. Date: Jun. 29, 2023

(54) RANDOM ACCESS RADIO NETWORK TEMPORARY IDENTIFIER (RA-RNTI) WITH PHYSICAL RANDOM ACCESS CHANNEL (PRACH) REPETITION

(71) Applicant: QUALCOMM Incorporated, San Diego, CA (US)

(72) Inventors: Xiaoxia ZHANG, San Diego, CA (US); Jing SUN, San Diego, CA (US); Changlong XU, Beijing (CN); Aleksandar DAMNJANOVIC, Del Mar, CA (US); Mahmoud TAHERZADEH BOROUJENI, San Diego, CA (US); Tao LUO, San Diego, CA (US)

(21) Appl. No.: 17/996,454

(22) PCT Filed: May 15, 2020
(86) PCT No.: PCT/CN2020/090669

§ 371 Date: Oct. 18, 2022

(51) Int. Cl. H04W 74/08; H04W 74/00; H04W 74/04

(52) U.S. Cl. CPC H04W 74/0833; H04W 74/006; H04W 74/04

(57) ABSTRACT

Wireless communication systems and methods related to random access in a wireless communication network are provided. A user equipment (UE) receives a configuration indicating a random access preamble for a random access associated with multiple random access occasions (ROs). The UE transmits the random access preamble in one or more of the multiple ROs. The UE determines one or more random access-radio network temporary identifiers (RA-RNTIs) for the multiple ROs. The UE monitors for a random access response (RAR) message based on the one or more determined RA-RNTIs in a RAR window associated with the multiple ROs.

### TECHNICAL FIELD

This application relates to wireless communication systems, and more particularly to random access in a wireless communication network.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

A UE may initiate a network access by performing a random access procedure with a BS. For instance, the UE may transmit a random access preamble using a random access resource in a physical random access channel (PRACH). After transmitting the random access preamble, the UE may monitor a downlink control channel (PDCCH) for a random access response (RAR) identified by a random access radio network temporary identifier (RA-RNTI) during an RAR window. The RA-RNTI may be dependent on the time and/or frequency resource locations (e.g., time and/or frequency resource indexes) of the random access resource. In some network deployment scenarios, where a transmission power spectral density (PSD) in a spectrum is restricted by a regulation, it may be desirable for a UE to transmit a random access preamble with repetitions, for example, using multiple random access resources in frequency and/or time, to increase the likelihood of a BS detecting the random access preamble. Additionally, the transmission of a random access preamble with repetitions can improve the coverage of random access.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication performed by a user equipment (UE), the method includes receiving a configuration indicating a random access preamble for a random access associated with multiple random access occasions (ROs); transmitting the random access preamble in one or more of the multiple ROs; determining one or more random access-radio network temporary identifiers (RA-RNTIs) for the multiple ROs; and monitoring for a random access response (RAR) message based on the one or more determined RA-RNTIs in a RAR window associated with the multiple ROs.

In an additional aspect of the disclosure, a method of wireless communication performed by a base station, the method includes transmitting a configuration indicating a random access preamble for a random access associated with multiple random access occasions (ROs); receiving, from a user equipment (UE), the random access preamble in one or more ROs of the multiple ROs; determining one or more random access-radio network temporary identifiers (RA-RNTIs) for the multiple ROs; and transmitting, in response to the random access preamble in a random access response (RAR) window associated with the multiple ROs, a RAR message based on the one or more determined RA-RNTIs.

In an additional aspect of the disclosure, a user equipment (UE) includes a transceiver configured to receive a configuration indicating a random access preamble for a random access associated with multiple random access occasions (ROs); and transmit the random access preamble in one or more of the multiple ROs; and a processor configured to determine one or more random access-radio network temporary identifiers (RA-RNTIs) for the multiple ROs; and monitor for a random access response (RAR) message based on the one or more determined RA-RNTIs in a RAR window associated with the multiple ROs.

In an additional aspect of the disclosure, a base station (BS) includes a transceiver configured to transmit a configuration indicating a random access preamble for a random access associated with multiple random access occasions (ROs); and receive, from a user equipment (UE), the random access preamble in one or more ROs of the multiple ROs; and a processor configured to determine one or more random access-radio network temporary identifiers (RA-RNTIs) for the multiple ROs, where the transceiver is further configured to transmit, in response to the random access preamble in a random access response (RAR) window associated with the multiple ROs, a RAR message based on the one or more determined RA-RNTIs.

In an additional aspect of the disclosure, a non-transitory computer-readable medium having program code recorded thereon, the program code including code for causing a user equipment (UE) to receive a configuration indicating a random access preamble for a random access associated with multiple random access occasions (ROs); code for causing the UE to transmit the random access preamble in one or more of the multiple ROs; code for causing the UE to determine one or more random access-radio network temporary identifiers (RA-RNTIs) for the multiple ROs; and code for causing the UE to monitor for a random access response (RAR) message based on the one or more determined RA-RNTIs in a RAR window associated with the multiple ROs.

In an additional aspect of the disclosure, a non-transitory computer-readable medium having program code recorded thereon, the program code includes code for causing a base station (BS) to transmit a configuration indicating a random access preamble for a random access associated with multiple random access occasions (ROs); code for causing the BS to receive, from a user equipment (UE), the random access preamble in one or more ROs of the multiple ROs; code for causing the BS to determine one or more random access-radio network temporary identifiers (RA-RNTIs) for the multiple ROs; and code for causing the BS to transmit, in response to the random access preamble in a random access response (RAR) window associated with the multiple ROs, a RAR message based on the one or more determined RA-RNTIs.

In an additional aspect of the disclosure, a user equipment (UE) includes means for receiving a configuration indicating a random access preamble for a random access associated with multiple random access occasions (ROs); means for transmitting the random access preamble in one or more of the multiple ROs; means for determining one or more random access-radio network temporary identifiers (RA-RNTIs) for the multiple ROs; and means for monitoring for a random access response (RAR) message based on the one or more determined RA-RNTIs in a RAR window associated with the multiple ROs.

In an additional aspect of the disclosure, a base station (BS) includes means for transmitting a configuration indicating a random access preamble for a random access associated with multiple random access occasions (ROs); means for receiving, from a user equipment (UE), the random access preamble in one or more ROs of the multiple ROs; means for determining one or more random access-radio network temporary identifiers (RA-RNTIs) for the multiple ROs; and means for transmitting, in response to the random access preamble in a random access response (RAR) window associated with the multiple ROs, a RAR message based on the one or more determined RA-RNTIs.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frame structure according to some aspects of the present disclosure.

FIG. 3A is a signaling diagram illustrating a random access method according to some aspects of the present disclosure.

FIG. 3B illustrates a random access preamble transmission scheme according to some aspects of the present disclosure.

FIG. 3C illustrates a random access response (RAR) transmission scheme according to some aspects of the present disclosure.

FIG. 4 illustrates a random access preamble transmission scheme using multiple ROs according to some aspects of the present disclosure.

FIG. 5 illustrates a random access preamble transmission scheme using multiple ROs according to some aspects of the present disclosure.

FIG. 6 illustrates a random access preamble transmission scheme using multiple ROs according to some aspects of the present disclosure.

FIG. 7 illustrates a random access preamble transmission scheme using multiple ROs according to some aspects of the present disclosure.

FIG. 8A illustrates an RAR transmission scheme for a multiple RO-based random access according to some aspects of the present disclosure.

FIG. 8B illustrates an RAR transmission scheme for a multiple RO-based random access according to some aspects of the present disclosure.

FIG. 8C illustrates an RAR transmission scheme for a multiple RO-based random access according to some aspects of the present disclosure.

FIG. 9 is a flow diagram of a random access method according to some aspects of the present disclosure.

FIG. 10 illustrates a random access preamble transmission scheme using multiple ROs according to some aspects of the present disclosure.

FIG. 11 is a block diagram of a user equipment (UE) according to some aspects of the present disclosure.

FIG. 12 is a block diagram of an exemplary base station (BS) according to some aspects of the present disclosure.

FIG. 13 is a flow diagram of a wireless communication method according to some aspects of the present disclosure.

FIG. 14 is a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜0.99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI). Additional features may also include having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Some studies have been conducted for NR-U deployment over 5 gigahertz (GHz) unlicensed bands. Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. In a 5 GHz bands, a UE and/or a BS may transmit with a power spectral density (PSD) of about 10 decibel-milliwatts-per-megahertz (dBm/MHz) to about 11 dBm/MHz depending on the regions. The FCC regulation is proposing a stricter PSD requirement for 6 GHz bands, for example, to protect incumbents such as video camera communications in the 6 GHz bands. For instance, in a 6 GHz band, a UE may transmit with a PSD of about −1 dBm/MHz and a BS may transmit with a PSD of about 5 dBm/MHz. In NR-U Release 16, transmissions for UEs are specified based on a 20 MHz transmission bandwidth with a transmit power at about 23 dBm. For instance, uplink interlaced waveforms were introduced for the physical uplink control channel (PUCCH), physical uplink shared channel (PUSCH), and physical random access channel (PRACH) to meet the PSD requirement in the 5 GHz band. An interlaced waveform transmission may refer to a transmission occupying a frequency interlace, which may include a set of resource blocks (RBs) spaced apart from each other by one more other RBs in a frequency band.

Given the lower PSD requirement in the 6 GHz bands, where a UE is limited to transmit with a 11 dBm/MHz lower PSD and a BS is limited to transmit with a 5 dBm/MHz lower PSD than in the 5 GHz bands, the link budget is reduced significantly. Additionally, there is a mismatch of about 6 dBm/MHz between the UL PSD requirement and the DL PSD requirement, resulting in a weaker or lower link budget for UL than for DL. The reduced link budget and the mismatch between the UL and DL link budgets can impact random access in a network. If a BS is unable to detect a random access preamble from a UE, the UE may not gain access to the network. One way to achieve a similar link budget in a 6 GHz band as in a 5 GHz band is to increase the BW occupancy of a random access preamble transmission, for example, by using a longer random access preamble sequence or repeating a random access preamble so that the transmission may occupy a wider frequency BW. For example, NR-U Release 16 defines a random access preamble length of 571 for a subcarrier spacing (SCS) of 30 kilohertz (kHz) and a random access preamble length of 1151 for an SCS of 15 kHz so that a random access preamble may span a BW of about 20 MHz. Alternatively, a UE may transmit a long random access preamble in time or repeating a random access preamble in time. In any case, in order to satisfy a PSD requirement and to achieve a certain link budget, a UE may transmit a longer random access preamble or repeating a random access preamble using multiple random access opportunities (ROs) (e.g., multiple random access resources). As discussed above, a UE may monitor for an RAR after transmitting a random access preamble based on a random access radio network temporary identifier (RA-RNTI) that is determined based on a random access resource or RO used for the random access preamble transmission. When a UE transmits a random access preamble using multiple ROs, it may be unclear as to how the UE may compute an RA-RNTI for the multiple ROs and/or determine an RAR window for RAR monitoring.

The present application describes mechanisms for determining RA-RNTI(s) and/or an RAR window for a random access that uses multiple ROs. For example, a BS may transmit a random access configuration indicating a random access preamble pool and associated ROs that a UE may use for random access. In some instances, the BS may broadcast a system information block (SIB) including the random access configuration. A UE may select a random access preamble from the pool and multiple ROs from the associated ROs. The UE may transmit the selected random access preamble in the selected multiple ROs. In some instances, the selection of the random access preamble and/or the multiple ROs can be a random selection. The random access preamble may include multiple PRACH preamble sequences. In some instances, the multiple PRACH preamble sequences are different sequences that are associated with each other. In some instances, the multiple PRACH preamble sequences may be repetitions of a PRACH preamble sequence, which may be referred to as a repeated preamble. The random access preamble transmission using the multiple ROs may be referred to as a multiple RO-based random access preamble transmission or a multiple RO-based random access. The UE transmitting the multiple RO-based random access preamble may be referred to as a multiple RO access-based UE. After transmitting the random access preamble in the multiple ROs, the UE may determine one or more RA-RNTIs for the multiple ROs according to some rules, which may be predetermined or indicated by the BS, for example, in the random access configuration.

In some aspects, the UE may determine a single RA-RNTI for the multiple ROs based on a predetermined RO among the multiple ROs. Accordingly, the UE may monitor for an RAR from the BS based on the single RA-RNTI during an RAR window. In some other aspects, the UE may determine an RA-RNTI for each RO of the multiple ROs. In other words, there is a one-to-one correspondence between the RA-RNTIs and the ROs. Accordingly, the UE may monitor for an RAR from the BS based on multiple RA-RNTIs determined for the multiple ROs during an RAR window. The RAR window may begin after an earliest RO of the multiple ROs, after a last RO of the multiple ROs, or after any RO of the multiple ROs. In some aspects, the BS may include a configuration for the RAR window in the random access configuration.

In some aspects, the BS may configure different random access preamble pools for multiple RO-based random access and single RO-based random access. A single RO-based random access refers to a UE transmitting a random access preamble in a single RO. The UE using a single RO for random access may be referred to as a legacy UE or a single RO access-based UE. The BS may configure some ROs for sharing between multiple RO-based random access and single RO-based random access. The BS may also configure some dedicated ROs for exclusive use by multiple RO-based random access. As such, a UE may select a random access preamble from a multiple RO-based random access preamble pool and may select multiple ROs from the dedicated ROs or the shared ROs and transmit the random access preamble in the multiple ROs. When the UE transmit a random access preamble in multiple ROs selected from the dedicated ROs, the UE may determine a single RA-RNTI for the multiple ROs based on a predetermined RO among the multiple ROs for RAR monitoring. Alternatively, when the UE transmit a random access preamble in multiple ROs selected from the shared ROs, the UE may determine an RA-RNTI for each RO of the multiple ROs and perform RAR monitoring based on each RA-RNTI.

In some aspects, the UE may determine a single RA-RNTI for the multiple ROs based on a function associated with the multiple ROs. For instance, a new function for computing RA-RNTI may be defined based on time and/or frequency locations of each RO of the multiple ROs.

Aspects of the present disclosure can provide several benefits. For example, the specification or indication of the rules for determining RA-RNTI(s) for multiple RO-based random access can facilitate the RA-RNTI determination for multiple RO-based random access. The use of a single RA-RNTI based on predetermined RO of the multiple ROs for RAR monitoring can be simple and may leverage the current RA-RNTI computation mechanisms in 3GPP. The use of the multiple RA-RNTIs (with the one-to-one correspondence between the RA-RNTIs and the ROs) can also leverage the current RA-RNTI computation mechanisms in 3GPP and may enable a BS to respond to multiple UEs (e.g., a multiple RO access-based UE and a single RO access-based UE) by broadcasting a single RAR message (e.g., a random access message 2 in a four-step random access or a random access message B in a two-step random access) as will be discussed more fully herein. The use of dedicated ROs for multiple RO-based random access or shared ROs for sharing between multiple RO-based random access and single RO-based random access can provide flexibility in random access and reduce complexity in RAR monitoring at the UE and/or flexibility in RAR responding at the BS when dedicated ROs are used. The use of a new function can provide further flexibility in random access with multiple ROs.

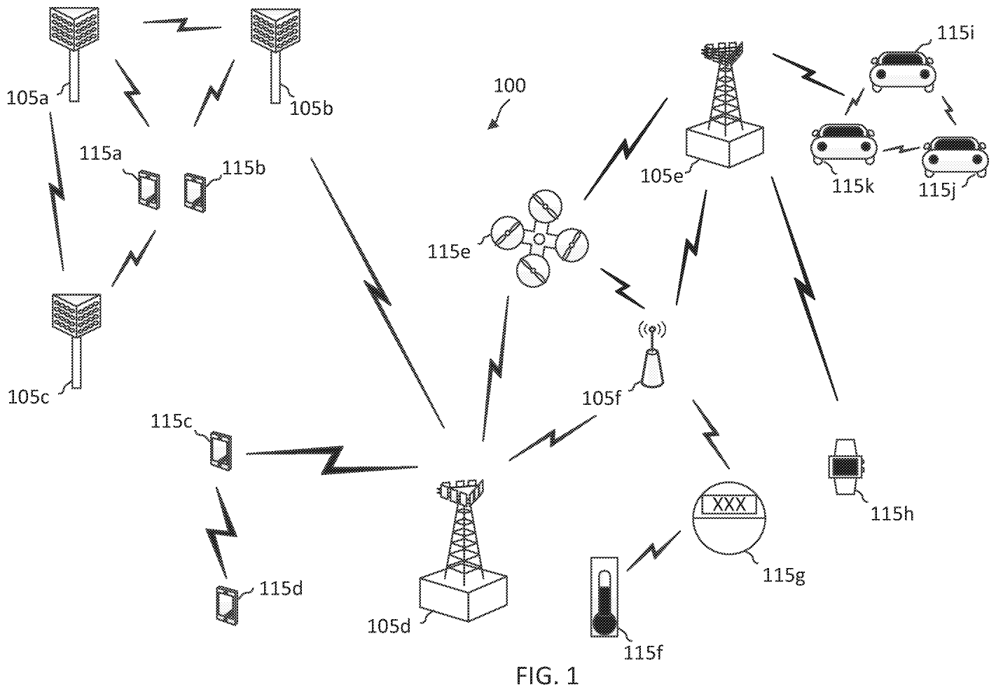

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 1050 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with an RAR. The RAR may include a detected random access preamble identifier (ID) corresponding to the random access preamble, timing advance (TA) information, a UL grant, a temporary cell-radio network temporary identifier (C-RNTI), and/or a backoff indicator. Upon receiving the RAR, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting an RAR and a connection response in a single transmission. In some aspects, the UE 115 may transmit a random access preamble in a single random access resource or a single RO. In some aspects, the UE 115 may transmit a random access preamble in multiple ROs, where the random access preamble may include multiple parts each transmitted in one of the multiple ROs, as will be discussed more fully herein.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate in an unlicensed band having a restrictive PSD requirement or over a wide area (in a licensed band or an unlicensed band) requiring an extended reach. In order to enable a UE 115 to gain access to the network 100 and synchronize to a BS 105, the network 100 may allow the UE 115 to transmit a random access preamble using multiple ROs. In some instances, the multiple RO-based random access preamble transmission can be over multiple ROs in frequency. In some other instances, the multiple RO-based random access preamble transmission can be over multiple ROs in time.

As discussed above, a UE may monitor for an RAR after transmitting a random access preamble based on an RA-RNTI that is determined based on a random access resource or RO used for the random access preamble transmission. To facilitate a UE 115 in monitoring an RAR for a random access preamble transmitted using multiple ROs, a set of rules may be defined for determining RA-RNTI(s) and/or RAR window for multiple RO-based random access preamble transmission. The set of rules may be predetermined or indicated by the BS 105, for example, in RMSI and/or OSI. In some aspects, the set of rules may specify a predetermined RO among the multiple ROs for determining a single RA-RNTI for the multiple ROs. Accordingly, the UE 115 may determine a single RA-RNTI based on the predetermined RO among the multiple ROs and monitor for an RAR for the random access preamble based on the single RA-RNTI. Upon the BS 105 detecting any parts of the random access preamble in any of the multiple RO, the BS 105 may respond by transmitting an RAR based on a single RA-RNTI determined from the predetermined RO.

In some aspects, the set of rules may specify that a RA-RNTI is to be determined for each RO of the multiple ROs based on each RO. In other words, there may be multiple RA-RNTIs associated with a single multiple RO-based random access preamble transmission. Accordingly, the UE 115 may determine a RA-RNTI for each RO of the multiple ROs based on each corresponding RO and monitor for an RAR for the random access preamble based on each RA-RNTI. The BS 105 may respond to each part of the random access preamble based on an RA-RNTI determined from an RO where the corresponding part is detected. In some other instances, the BS 105 may not respond to one of the detected part of the random access preamble instead of all of the detected parts of the random access preamble.

In some aspects, the UE 115 may determine whether to determine a single RA-RNTI or multiple RA-RNTIs for the multiple ROs based on whether the multiple ROs are dedicated for multiple RO-based random access or single RO-based random access. In some other aspects, the set of rules may specify a new function for determining an RA-RNTI for the multiple ROs. For instance, the function may be dependent on the time and/or frequency locations of each RO of the multiple ROs. Accordingly, the UE 115 may determine a single RA-RNTI as a function of the multiple ROs. In some aspects, the UE 115 may begin RAR monitoring after a certain RO of the multiple ROs, which may be based on a pre-configuration or indicated by the BS 105. Mechanisms for performing multiple RO-based random access are described in greater detail herein.

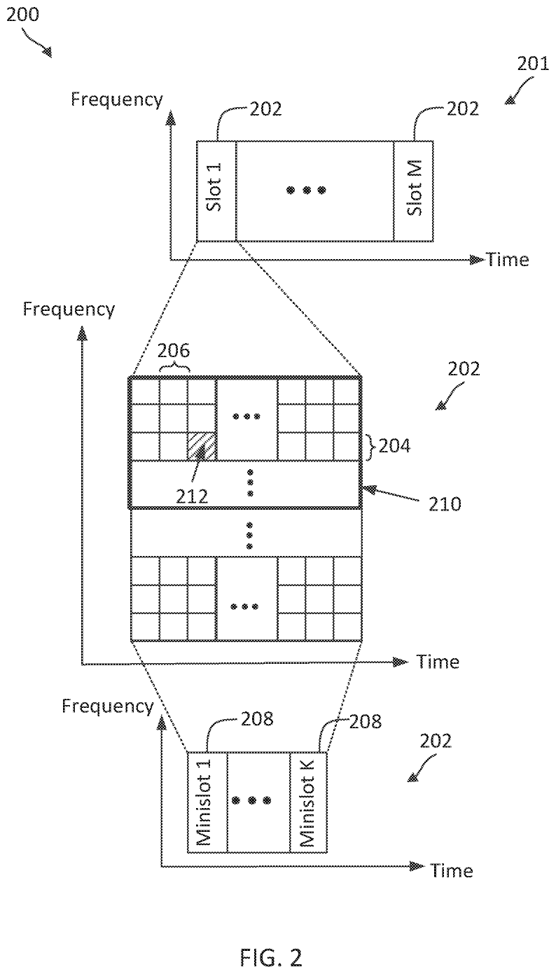

FIG. 2 illustrates a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The transmission frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel BW, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In an example, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

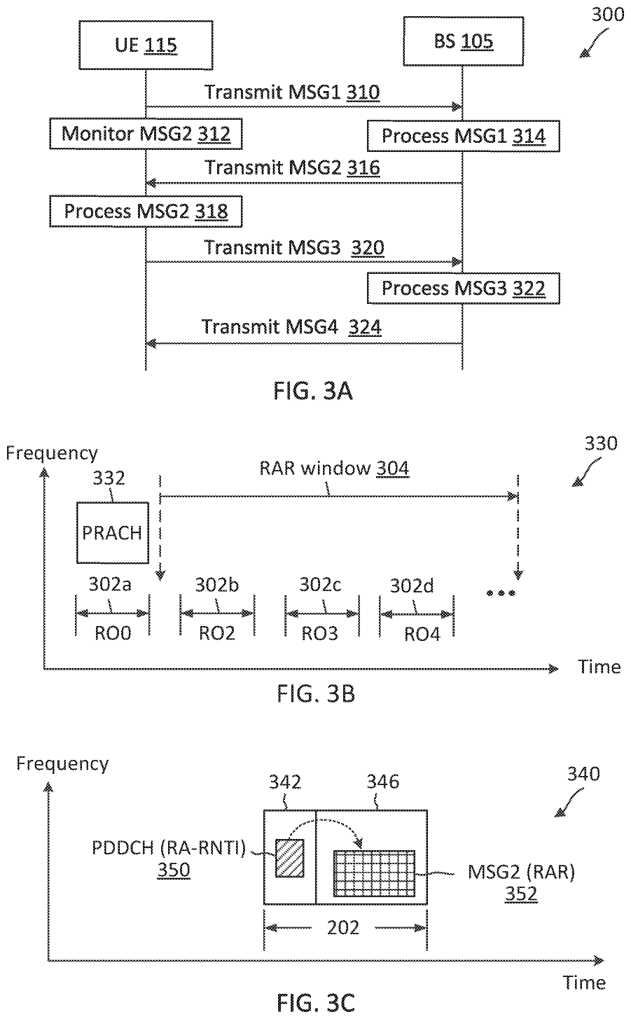

FIGS. 3A-3C are discussed in relation to each other to illustrate a four-step random access procedure. FIG. 3A is a signaling diagram illustrating a random access method 300 of performing a four-step random access procedure according to embodiments of the present disclosure. Steps of the method 300 can be executed by computing devices (e.g., a processor, processing circuit, and/or other suitable component) of wireless communication devices, such as the BS 105 and the UE 115. As illustrated, the method 300 includes a number of enumerated steps, but embodiments of the method 300 may include additional steps before, after, and in between the enumerated steps. In some embodiments, one or more of the enumerated steps may be omitted or performed in a different order. The method 300 illustrates one BS 105 and one UE 115 for purposes of simplicity of discussion, though it will be recognized that embodiments of the present disclosure may scale to many more UEs 115 and/or BS s 105.

At action 310 the UE 115 transmits a MSG1 carrying a random access preamble according to a PRACH configuration. For instance, the BS 105 may broadcast the PRACH configuration in a SIB. The PRACH configuration may indicate random access preamble formats, for example, in a random access preamble pool. The PRACH configuration may also indicate random access opportunities (e.g., time-frequency resources or REs 212) that may be used for transmitting a random access preamble. In some instances, the MSG1 also includes a payload and a random access identifier (ID). The random access ID for a particular sent random access preamble can be derived based on the frequency-time resource used by the UE 115 to send the particular random access preamble. Thus, there is a one-to-one mapping between the ROs and the random access IDs. The random access IDs are referred to as RA-RNTIs.

FIG. 3B illustrates a random access preamble transmission scheme 330 according to some aspects of the present disclosure. The scheme 330 may be employed by the UE 115 and the BS 105 for communications. The x-axis represents time in some arbitrary units. The y-axis represents frequency in some arbitrary units. For instance, the PRACH configuration may indicate a plurality of ROs 302. The ROs 302 are shown as 302a, 302b, 302c, and 302d and denoted as RO1, RO2, RO3, and RO4, respectively. Although FIG. 3B illustrates four ROs 302 at different time, it should be understood that in other examples there can be any suitable number of ROs 302 located in any suitable time and/or frequency locations. In the illustrated example of FIG. 3, the UE 115 transmits a PRACH preamble sequence 332 in a single RO 302a. The PRACH preamble sequence 332 may correspond to the random access preamble transmitted by the UE 115 at action 310. The PRACH preamble sequence 332 is a physical waveform sequence.

Returning to FIG. 3A, at action 312, after sending the MSG1, the UE 115 monitors for a MSG2 from the BS 105 within an RAR window (e.g., the RAR window 304 in FIG. 3B). In some instances, the UE 115 sends a random access preamble in mini-slot I of Kth subframe, a corresponding RAR window begins at mini-slot J of (N+K)th subframe and spans a duration of L, where N may be greater than or equals 0 and J and L may be defined in one of the SIB s broadcasted by the BS 105. The UE 115 monitors for an RAR based on the random access ID to identify whether a received RAR is a response to a random access preamble transmitted by the UE 115.

At action 314, upon detecting the MSG1, the BS 105 processes the MSG 1. For each detected random access preamble, the BS 105 may determine UL transmission timing of the UE 115 and assign a UL resource and a temporary ID to the UE 115 for sending a subsequent message. The BS 105 may assign the UL resources based on the random access message transmission configuration, for example, the tone spacing, the symbol timing, the starting time, and/or the ending time of the UL control and data channels. The BS 105 may identify a subsequent (or next) random access message (e.g., MSG 3) from the UE 115 by the temporary ID. The temporary IDs are referred to as temporary C-RNTIs.

At action 316, for each detected random access preamble, the BS 105 transmits a MSG2 according to the random access message transmission configuration. The MSG2, which is the RAR, is a response to the random access preamble received from the UE 115 at action 310. A RAR may be carried in one or more mini-slots or one or more slots. Each RAR may include a control portion (e.g., in a PDCCH) and a data portion (e.g., in a PDSCH). The MSG2 carries an UL grant that may be used by the UE 115 to transmit content to the BS 105. The control portion is generated based on the random access ID of a corresponding random access preamble. The data portion carries a corresponding assigned resource, a corresponding assigned temporary ID, and corresponding timing advance information determined based on corresponding uplink transmission timing. In some instances, the MSG 2 includes the assigned resources, the temporary ID, and the timing advance information.

FIG. 3C illustrates an RAR transmission scheme 340 according to some aspects of the present disclosure. The scheme 340 may be employed by the UE 115 and the BS 105 for communications. The x-axis represents time in some arbitrary units. The y-axis represents frequency in some arbitrary units. For instance, the BS 105 transmits a PDCCH 350 based on an RA-RNTI associated with the random access preamble (e.g., the PRACH preamble sequence 332) transmitted by the UE 115 at action 310. The RA-RNTI may be a function of the time and/or frequency resource of the RO 302a (RO1) where the UE 115 transmitted the PRACH preamble sequence 332. The PDCCH 350 may be transmitted in a control portion 342 of a slot 202. The slot 202 may correspond to a slot within the RAR window 304. The PDCCH 350 may indicate a schedule for a MSG2 352 in a data portion 346 of the slot 202. The MSG2 352 may correspond to the MSG2 transmitted by the BS 105 at action 316. In some aspects, the PDCCH 350 includes DCI including a cyclic redundancy check (CRC) masked by the RA-RNTI (e.g., by scrambling the CRC with the RA-RNTI). In some aspects, the MSG2 352 may include a record of the PRACH preamble sequence 332 that the MSG2 352 is responding to.

Returning to FIG. 3A, at action 318, upon detecting the MSG 2, the UE 115 processes the MSG2. For instance, the UE 115 retrieves the assigned resources, the temporary ID, and the timing advance information from the MSG2.

At action 320, the UE 115 transmits a MSG3, which carries a connection request (an RRC connection request) to the BS 105. In an example, the UE 115 responds to the RAR received from the BS 105 by transmitting the MSG 3. The MSG3 may be sent according to the assigned resource, the temporary ID, the timing advancement information, and the random access message transmission configuration. The MSG3 may be carried in one or more mini-slots or one or more slots.

At action 322, upon receiving the MSG 3, the BS 105 processes the MSG3 and determines that the MSG 3 is sent in response to an RAR by the temporary ID. Accordingly, the BS 105 determines that the UE assigned to the temporary ID desires to connect to the network. At action 324, the BS 105 acknowledges receiving the MSG 3 by sending a MSG 4, which carries a connection response (an RRC connection response) to the UE 115. The MSG 4 may be carried in one or more mini-slots or one or more slots.

Subsequently, the UE 115 may transmit an ACK for MSG 4 to the BS 105 and continue to initiate a registration process with the BS 105.

As discussed above, a UE 115 may also perform a two-step random access procedure, where the UE 115 transmits a MSGA and the BS 105 may respond with a MSGB. The MSGA may include a random access preamble (e.g., the PRACH preamble sequence 352) and a connection request. The MSGB may include an RAR and a connection response. The UE 115 may transmit the MSGA in a RO similar to the ROs 302. The BS may transmit the MSGB based on an RA-RNTI derived from the RO where the MSGA is detected, for example, using similar mechanism as the transmission of the MSG2 shown in FIG. 3C.

As discussed above, in some network deployments, it may be desirable for a UE 115 to transmit a random access preamble in a frequency band (e.g., an unlicensed band) using multiple ROs in frequency, for example, to increase a frequency BW occupancy so that the UE 115 does not have to reduce its transmit power (e.g., at about 23 dBm) and yet meeting a certain PSD requirement of the frequency band. Similarly, it may be desirable for a coverage-limited UE 115 to transmit a random access preamble using multiple ROs in time, for example, to allow a BS 105 to collect more power for the random access preamble detection.

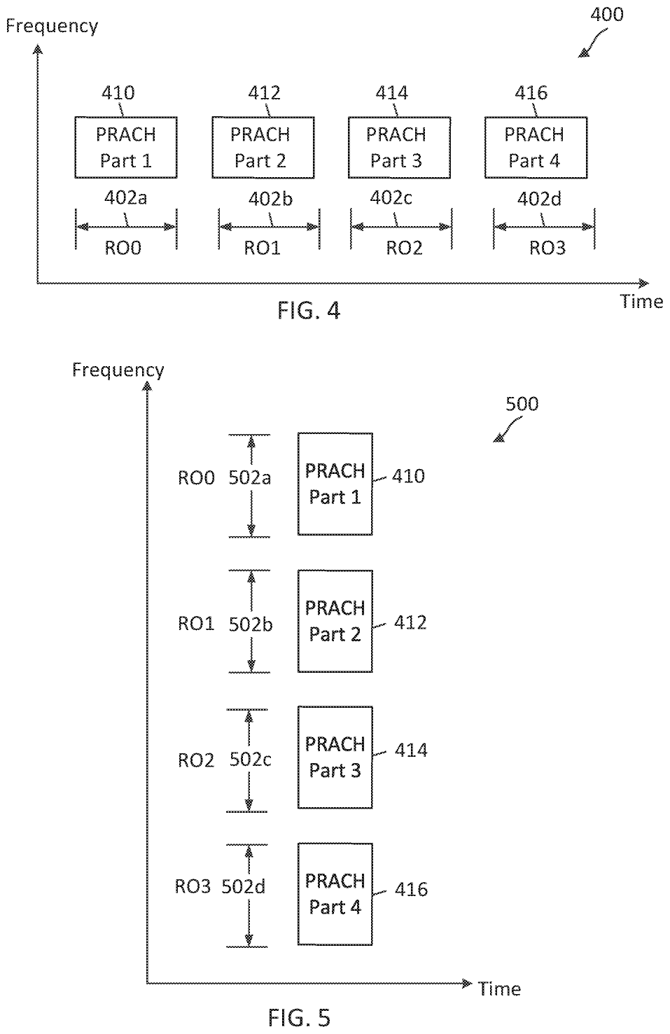

FIG. 4 illustrates a random access preamble transmission scheme 400 using multiple ROs according to some aspects of the present disclosure. The scheme 400 may be employed by the UE 115 and the BS 105 for communications. The x-axis represents time in some arbitrary units. The y-axis represents frequency in some arbitrary units. As shown, the scheme 400 includes multiple ROs 402 in time. The ROs 402 are shown as 402a, 402b, 402c, and 402d and denoted as RO1, RO2, RO3, and RO4, respectively. Each RO 402 may be within a slot similar to the slot 202 of FIG. 2. The ROs 402 can be in consecutive slots or non-consecutive slots. The ROs 420 can occupy a full slot 202 or a portion of slot 202. The UE 115 may initiate a network access with the BS 105 by transmitting a random access preamble including a PRACH preamble sequence part 1 410, a PRACH preamble sequence part 2 412, a PRACH preamble sequence part 3 414, and a PRACH preamble sequence part 4 416. The UE 115 may transmit each of the PRACH preamble sequences 410, 412, 414, and 416 in one of the multiple ROs 402. The PRACH preamble sequences 410, 412, 414, and 416 are physical waveform sequences. In some aspects, each of the PRACH preamble sequences 410, 412, 414, and 416 correspond to the same PRACH preamble sequence. In other words, the UE 115 transmits four repetitions of the PRACH preamble sequence. In some other aspects, the PRACH preamble sequence 410, 412, 414, and 416 are associated with each other to form a long random access preamble for transmitting over multiple ROs 402. For instance, the PRACH preamble sequence 410, 412, 414, and 416 may be within a random access preamble pool and the random access preamble pool may be defined with an association for the PRACH preamble sequence 410, 412, 414, and 416. Although FIG. 4 illustrates the UE 115 transmitting the random access preamble in four ROs 402 (e.g., four slots 202), it should be understood that in other examples the UE 115 may transmit a random access preamble in any suitable number of ROs 402 (e.g., about 2, 3, 5 or more).

FIG. 5 illustrates a random access preamble transmission scheme 500 using multiple ROs according to some aspects of the present disclosure. The scheme 500 may be employed by the UE 115 and the BS 105 for communications. The x-axis represents time in some arbitrary units. The y-axis represents frequency in some arbitrary units. As shown, the scheme 500 includes multiple ROs 502 in frequency. The ROs 502 are shown as 502a, 502b, 502c, and 502d and denoted as RO1, RO2, RO3, and RO4, respectively. Each RO 502 may include a set of RBs similar to the RBs 210 of FIG. 2. The ROs 502 can be in consecutive RB sets or non-consecutive RB sets. The UE 115 may initiate a network access with the BS 105 by transmitting a random access preamble including a PRACH preamble sequence part 1 510, a PRACH preamble sequence part 2 512, a PRACH preamble sequence part 3 514, and a PRACH preamble sequence part 4 516. The UE 115 may transmit each of the PRACH preamble sequences 510, 512, 514, and 516 in one of the multiple ROs 502. The PRACH preamble sequences 510, 512, 514, and 516 are physical waveform sequences. In some aspects, each of the PRACH preamble sequences 510, 512, 514, and 516 correspond to the same PRACH preamble sequence. In other words, the UE 115 transmits four repetitions of the PRACH preamble sequence. In some other aspects, the PRACH preamble sequences 510, 512, 514, and 516 are associated with each other to form a long random access preamble for transmitting over multiple ROs 502. Although FIG. 5 illustrates the UE 115 transmitting the random access preamble in four ROs 502 (e.g., four sets of RBs 210), it should be understood that in other examples the UE 115 may transmit a random access preamble in any suitable number of ROs 502 (e.g., about 2, 3, 5 or more).

In some aspects, the UE 115 may implement the method 300 in conjunction with the scheme 400. For instance, the UE 115 may transmit a MSG1 including a random access preamble including the PRACH preamble sequences 410, 412, 414, and 416 using the multiple ROs 402 in time at action 310. In some other aspects, the UE 115 may implement the method 300 in conjunction with the scheme 500. For instance, the UE 115 may transmit a random access preamble including the PRACH preamble sequences 510, 512, 514, and 516 using the multiple ROs 402 in frequency at action 310. In some other aspects, the UE 115 may transmit a MSGA including a random access preamble including the PRACH preamble sequences 410, 412, 414, and 416 using the multiple ROs 402 in time as shown in FIG. 4. In some other aspects, the UE 115 may transmit a MSGA including a random access preamble including the PRACH preamble sequences 510, 512, 514, and 516 using the multiple ROs 402 in frequency as shown in FIG. 5.

To facilitate a UE 115 in monitoring a MSG2 or MSGB for a random access preamble transmitted using multiple ROs, the present disclosure provides techniques for determining RA-RNTI(s) when a UE 115 utilizes multiple ROs for random access preamble transmissions.

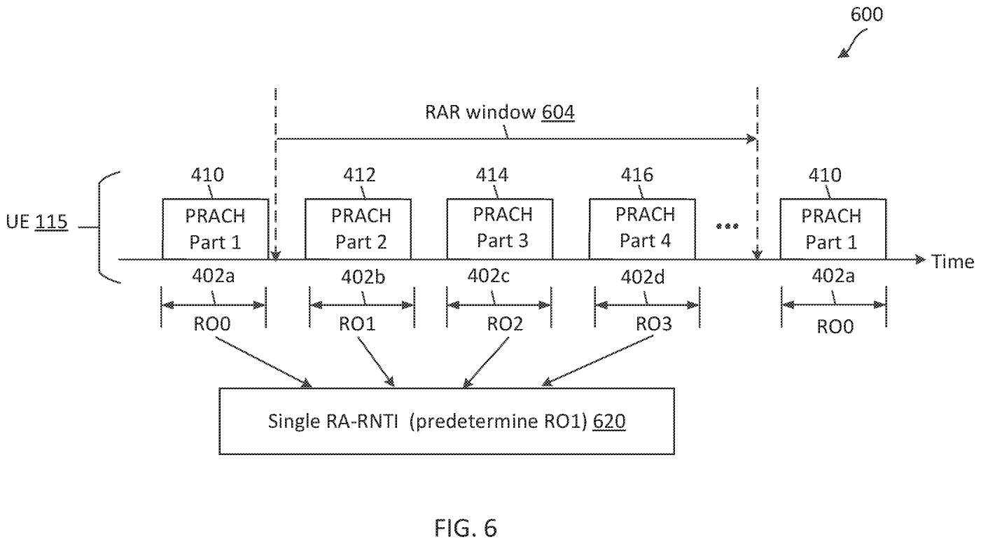

FIG. 6 illustrates a random access preamble transmission scheme 600 using multiple ROs according to some aspects of the present disclosure. The scheme 600 may be employed by a UE 115 and a BS 105 in a network such as the network 100 for communication. In some aspects, the BS 105 and the UE 115 may employ the scheme 600 in conjunction with the method 300. The x-axis represents time in some arbitrary units. The y-axis represents frequency in some arbitrary units. The scheme 600 is illustrated using the same RO configuration (with multiple ROs in time) and random access preamble transmission configuration as the scheme 400 and may use the same reference numerals as FIG. 4 for simplicity's sake. Although the scheme 600 is illustrated using multiple ROs in time, it should be understood that similar RA-RNTI determination mechanisms can be applied to multiple ROs in frequency as shown in FIG. 5.

In the scheme 600, a BS 105 may transmit a configuration indicating a pool of random access preamble sequences for a multiple RO-based random access. The configuration may also indicate a pool of ROs for random access. The BS 105 may indicate the configuration in a SIB. A UE 115 may select a random access preamble from the random access preamble pool and multiple ROs from the RO pool and transmit the random access preamble in the selected multiple ROs. In the illustrated example of FIG. 6, the UE 115 transmits the random access preamble including PRACH preamble sequences 410, 412, 414, and 416 each in one of the multiple ROs 402a, 402b, 402c, and 402d. The UE 115 may determine a single RA-RNTI 620 for the multiple ROs 402 where the random access preamble is transmitted.

In some aspects, the UE 115 may determine the single RA-RNTI 620 based on a predetermined RO among the ROs 402. The UE 115 may determine the RA-RNTI 620 using substantially similar mechanisms in a single RO-based random access preamble transmission in method 300 discussed above in relation to FIG. 3. For instance, the predetermined RO may correspond to the RO 402b (RO1). Accordingly, the UE 115 may determine the single RA-RNTI 620 based on time and/or frequency resources of the RO 402b. For instance, the UE 115 may compute the single RA-RNTI 620 in accordance with equation (1):

RA-RNTI=1+s_id+14×t_id+14×80×f_id+14×80×8×ul_carrier_id, (1)

where s_id represents the index of the first OFDM symbol of the predetermined RO (e.g., 0≤s_id<14), t_id represents the index of the first slot symbol of the predetermined RO in a system frame (e.g., 0≤t_id<80), f_id represents the index of the predetermined RO in the frequency domain (e.g., 0≤s_id<8), and ul_carrier_id represents the UL carrier used for the random access preamble transmission (e.g., 0=normal carrier, 1=supplement UL carrier).

In some aspects, the predetermined RO may be specified by a wireless communication standard such as the 3GPP. In some aspects, the BS 105 may indicate the predetermined RO among the multiple ROs 402 for determining the single RA-RNTI 620, for example, in a PRACH configuration. In some instances, the predetermined RO may correspond to an earliest RO (RO1) or an earliest repetition among the ROs 402. In some instances, the predetermined RO may correspond to a last RO (RO4) or a last repetition among the ROs 402. In general, the predetermined RO may be any RO (e.g., a k^{th}) among the set of multiple ROs 402 used for the multiple RO-based random access preamble transmission. In the illustrated example of FIG. 6, the BS 105 indicates that the second RO (RO1) as the predetermined RO for RA-RNTI computation. Accordingly, the UE 115 may monitor for an RAR (e.g., MSG2 in a four-step random access and MSGB in a two-step random access) in an RAR window 604 based on the single RA-RNTI 620 determined from RO1 (time/frequency resource), and the BS 105 may respond to the random access preamble based on the RA-RNTI 620. For instance, the BS 105 may transmit a PDCCH with a CRC masked by the single RA-RNTI 620, where the PDCCH may include a schedule for a MSG2 or MSGB for the UE 115, for example, similar to the RAR transmission in the scheme 340 discussed above in relation to FIG. 3C.

In some aspects, the RAR window 604 may be specified by a wireless communication standard such as the 3GPP. In some aspects, the BS 105 may indicate a configuration for the RAR window 604. In some instances, the RAR window 604 may start after an earliest RO (e.g., RO1) or repetition among the set of multiple ROs 402. In some instances, the RAR window 604 may start after a latest RO (RO4) or repetition among the set of multiple ROs 402. In some instances, the RAR window 604 may be defined in the same way irrespective of whether the UE 115 utilizes a single RO-based random access preamble or a multiple RO-based random access preamble for the random access. For instance, the RAR window 604 may begin K slot after an RO used for a random access preamble transmission. In general, the RAR window 604 may start after any RO among the set of multiple ROs 402. If the UE 115 fails to detect any RAR from the BS 105 within the RAR window 604, the UE 115 may reattempt to transmit another random access preamble in another set of multiple ROs 402 after the RAR window 604, for example, after a certain backoff. The UE 115 may select the same set of PRACH preamble sequences 410, 412, 414, and 416 or a different set of PRACH preamble sequences.

In some aspects, when the BS 105 desires to attempt early decoding or detection of a random access preamble, the BS 105 may configure an earlier RO of the multiple ROs 402 as the predetermined RO to allow the UE 115 to monitor for an RAR with a potential early decision from the BS 105. For instance, when the RAR window 604 begins after the earliest repetition or RO 402a as shown, the BS 105 may transmit an RAR to the UE 115 upon detecting the PRACH preamble sequence part 1 410 at the beginning of the RAR window 604. Depending when the UE receives the RAR, the UE 115 may not transmit all the PRACH preamble sequences 410, 412, 414, and 416. For example, if the UE receives the RAR before the third RO 402c, the UE may not transmit PRACH preamble sequence part 3 416 in RO 402c and PRACH preamble sequence part 4 418 in RO 402d.

In some aspects, the BS 105 may desire to transmit an RAR (a MSG2 or a MSGB) as a broadcast message. For instance, if the BS 105 detected two random access preambles from two UEs 115 in an RO (e.g., RO1), the BS 105 may transmit a single MSG2 or MSGB including an RAR for each detected random access preamble based on the RA-RNTI determined from RO1 to respond to both UEs 115. However, the use of a single RA-RNTI for a multiple RO-based random access preamble transmission can limit the use of a broadcast MSG2 or MSGB when single RO-based random access preamble transmissions and multiple RO-base random access preamble transmissions share the same RO pool. For instance, the BS 105 detected the PRACH preamble sequence part 1 410 from the multiple RO access-based UE 115 in the RO 402a (RO0) and a random access preamble from a single RO access-based random access preamble in the RO 402a (RO0). Since the multiple RO access-based UE 115 monitors for an RAR based on an RA-RNTI (e.g., RA-RNTI A) determined from the predetermined RO1 and the single RO access-based UE 115 monitors for an RAR based on an RA-RNTI (e.g., RA-RNTI B) determined from the RO0 (where the single RO access-based UE 115 transmitted the random access preamble), the BS 105 will have to transmit one RAR for the multiple-RO based UE 115 based on the RA-RNTI A and another RAR for the single RO access-based UE 115 based on the RA-RNTI B. Accordingly, in some aspects, it may be desirable to have a one-to-one correspondence between an RA-RNTI and an RO 402 so that a BS 105 may respond to a multiple RO access-based UE and single RO access-based UE 115 in a single broadcast MSG2 or MSGB to reduce network signaling overhead.

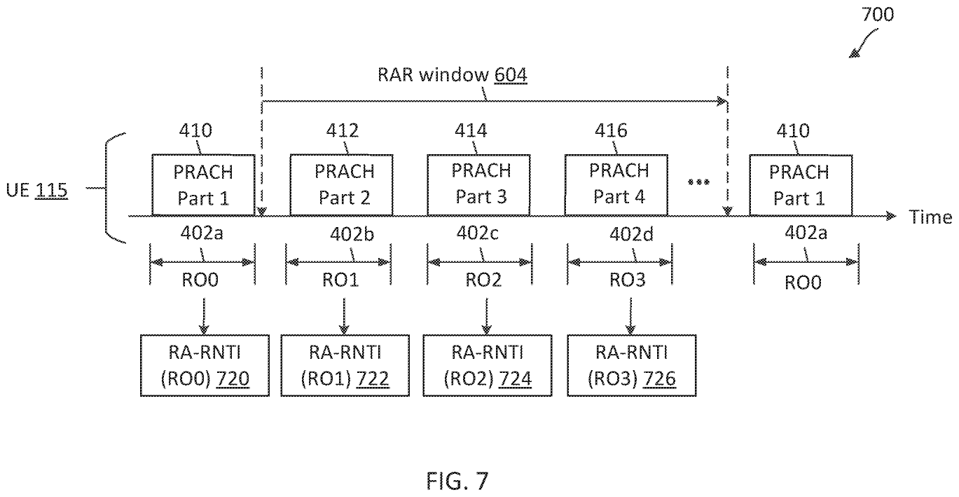

FIG. 7 illustrates a random access preamble transmission scheme 700 using multiple ROs according to some aspects of the present disclosure. The scheme 700 may be employed by a UE 115 and a BS 105 in a network such as the network 100 for communication. In some aspects, the BS 105 and the UE 115 may employ the scheme 700 in conjunction with the method 300. The x-axis represents time in some arbitrary units. The y-axis represents frequency in some arbitrary units. The scheme 700 is illustrated using the same RO configuration (with multiple ROs in time) and random access preamble transmission configuration as the scheme 400 and may use the same reference numerals at FIG. 4 for simplicity's sake. Although the scheme 700 is illustrated using multiple ROs in time, it should be understood that similar RA-RNTI determination mechanisms can be applied to multiple ROs in frequency as shown in FIG. 5.

Similar to the scheme 600, a BS 105 may indicate a pool of random access preambles and a pool of ROs for random access. However, in the scheme 700, the UE 115 may determine multiple RA-RNTIs for the multiple ROs 402 where the UE 115 transmitted the random access preamble. For instance, the UE 115 may determine an RA-RNTI for each RO 402 based on the corresponding RO 402. As shown, the UE 115 may determine a RA-RNTI 720 based on the RO0 (e.g., the RO 402a) where the PRACH preamble sequence part 1 410 is transmitted. The UE 115 may also determine a RA-RNTI 722 based on the RO1 (e.g., the RO 402b) where the PRACH preamble sequence part 2 412 is transmitted. The UE 115 may also determine a RA-RNTI 724 based on the RO2 (e.g., the RO 402c) where the PRACH preamble sequence part 3 414 is transmitted. The UE 115 may also determine a RA-RNTI 726 based on the RO3 (e.g., the RO 402d) where the PRACH preamble sequence part 4 416 is transmitted. In some instances, the UE 115 may determine each of the RA-RNTIs 720, 722, 724, and 726 in accordance with equation (1) discussed above in relation to FIG. 6.

After determining the multiple RA-RNTIs 720, 722, 724, and 726 for the multiple ROs 402, the UE 115 may monitor for an RAR based on the multiple RA-RNTIs 720, 722, 724, and 726. The monitoring based on the multiple RA-RNTIs 720, 722, 724, and 726 does not increase the number of PDCCH blind decodes at the UE 115, but rather the number of CRC mask checking. For instance, the UE 115 may apply a first mask to a CRC in a detected PDCCH using the RA-RNTI 720 (e.g., by scrambling the RC with the RA-RNTI 720). If the CRC check fails, the UE 115 may apply a second mask to the CRC using the RA-RNTI 722. If the CRC check fails, the UE 115 may apply a third mask to the CRC using the RA-RNTI 724, and so on. The additional complexity associated with the additional CRC mask checking may be low and affordable for a UE 115 performing an initial network access.

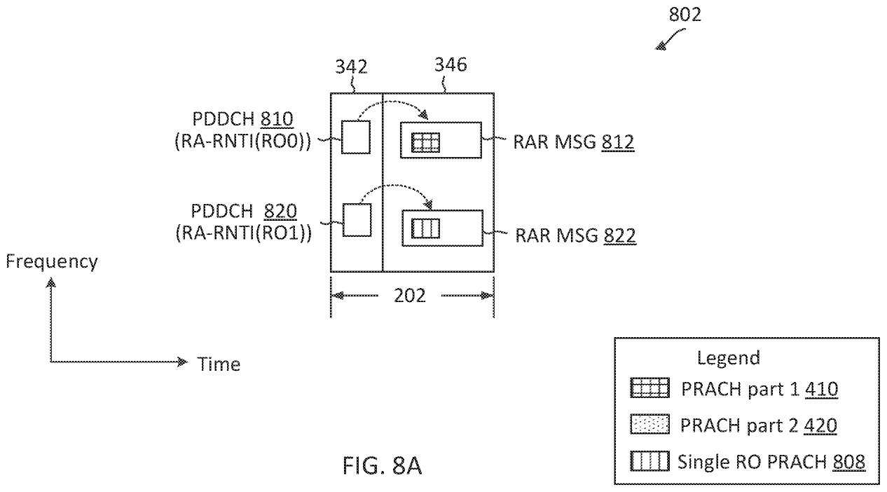

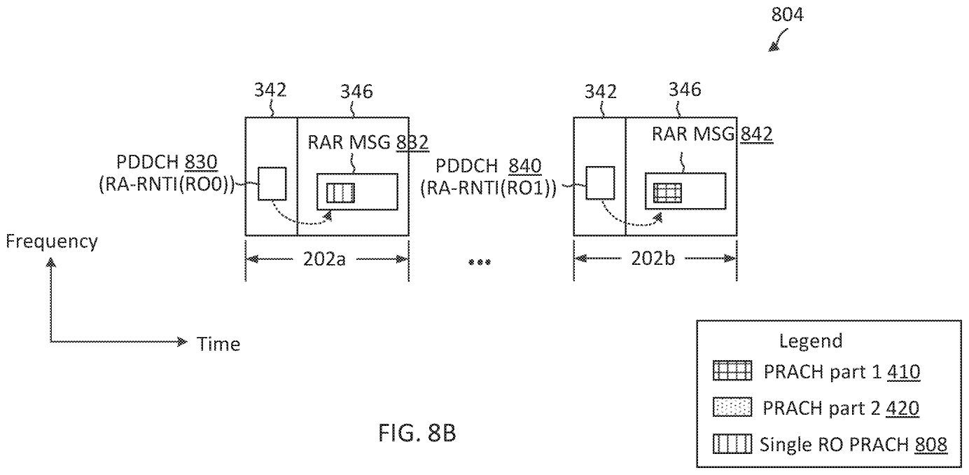

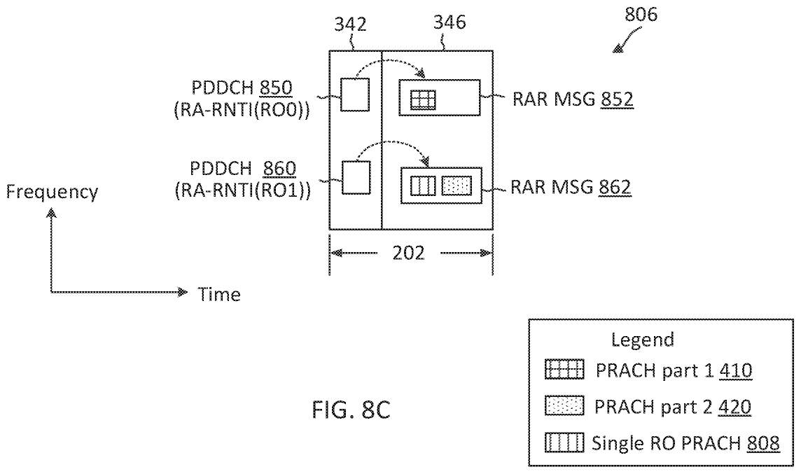

FIGS. 8A-8C are discussed in relation to FIG. 7 to illustrate various mechanisms a BS 105 may use to respond to the multiple RO access-based UE 115 transmitting the PRACH preamble sequences 410, 412, 414, and 416 in the multiple ROs 402. In FIGS. 8A-8C, the x-axes represent time in some arbitrary units, and the y-axes represent frequency in some arbitrary units. The scheme 802, 804, and 806 may be employed by a BS 105 and a UE 115 in a network such as the network 100 for communication. Additionally, the schemes 802, 804, and 806 are illustrated using a similar PDCCH/MSG transmission configuration as the scheme 330 and 340 and may use the same reference numerals as FIGS. 3B and 3C for simplicity's sake.

FIG. 8A illustrates an RAR transmission scheme 802 for a multiple RO-based random access preamble according to some aspects of the present disclosure. In the scheme 802, the BS 105 may include an RAR for a multiple RO access-based UE 115 in one MSG2 based on one RO of the multiple ROs 402. In other words, the BS 105 may detect one or more of the PRACH preamble sequence 410, 412, 414, and 416, but may respond to one of the PRACH preamble sequence 410, 412, 414, and 416. For instance, the BS 105 detected the PRACH preamble sequences part 1 410 in the RO 402a (RO0) and the PRACH preamble sequence part 2 412 in the RO 402b (RO1) from the multiple RO-based random access preamble transmission and decided to respond to the PRACH preamble sequence part 1 410. Thus, the BS 105 may transmit a first PDCCH 810 in a control portion 342 of the slot 202 based on a first RA-RNTI (RA-RNTI 720) computed from the RO0. The PDCCH 810 includes a CRC masked by the first RA-RNTI. The PDCCH 810 schedules a first RAR message 812 (e.g., MSG2 in a four-step random access and MSGB in a two-step random access) in a data portion 346 of the slot 202 in response to receiving the PRACH preamble sequence part 1 410. Accordingly, the BS 105 may transmit the first RAR message 812 in the data portion 346 of the slot 202. The first RAR message 812 may include the PRACH preamble sequence part 1 410 in the first RAR message 812 as part of the response. In some other instances, the BS 105 may determine to respond to the PRACH preamble sequence part 2 412 instead of the PRACH preamble sequence part 1 410, for example, using similar mechanisms as discussed for responding to the PRACH preamble sequence part 1 410.

In some instances, the BS 105 may also detect a random access preamble (e.g., a single RO-based PRACH 808) from a single RO access-based UE 115 in the RO 402b (RO1). The BS 105 may determine to respond to the single RO-based PRACH 808 in the same slot 202. Thus, the BS 105 may transmit a second PDCCH 820 in a control portion 342 of the slot 202 based on a second RA-RNTI (RA-RNTI 722) computed from the RO1. The PDCCH 820 includes a CRC masked by the second RA-RNTI. The PDCCH 820 schedules a second RAR message 822 (e.g., MSG2 in a four-step random access and MSGB in a two-step random access) in a data portion 346 of the slot 202 in response to receiving the single RO-based PRACH 806. Accordingly, the BS 105 transmits the second RAR message 822 in the data portion 346 of the slot 202. The second RAR message 822 may include the single RO-based PRACH 806 in response to the single RO-based PRACH 806. While the BS 105 also detected the PRACH preamble sequence part 2 412 in the RO1, the BS 105 may not include the PRACH preamble sequence part 2 412 in the second RAR message 822 since the first RAR message 810 already responded to the PRACH preamble sequence part 1 410.

The UE 115 may detect the first PDCCH 810 based on the first RA-RNTI (RA-RNTI 720) and the second PDCCH 820 based on the second RA-RNTI (RA-RNTI 722). Since the UE 105 may not be aware which PRACH preamble sequence 410, 412, 414, or 416 the BS 105 may detect, the UE 115 may decode the first RAR message 812 based on the schedule in the first PDCCH 810 and decode the second RAR message 822 based on the schedule in the second PDCCH 820. After decoding the first RAR message 812 and the second RAR message 822, the UE 115 may obtain the RAR for the PRACH preamble sequence part 1 410 from the first RAR message 812. The decoding of two PDSCHs (e.g., for the first RAR message 812 and the second RAR message 822) in a single slot 202 may be processing intensive. However, since a UE 115 may not have other significant processing on going during random access, the UE 115 may be able to support two PDSCH decoding in a single slot 202.

In some other aspects, the BS 105 may determine whether to respond to the PRACH preamble sequence part 410 detected in RO0 or the PRACH preamble sequence part 2 412 detected in RO1 depending on whether the BS 105 detected another random access preamble from another UE 115 in RO0 or RO1. For instance, since the BS 105 also detected the single RO-based PRACH 808 in RO1, the BS 105 may broadcast a RAR MSG based on the RA-RNTI 722 computed from RO1 to respond to both the PRACH preamble sequence part 2 412 and the single RO-based PRACH 808 to save signaling overhead instead of the separate RAR MSG 812 and RAR MSG 822 as shown. For instance, the RAR MSG may include the PRACH preamble sequence part 2 410 and the single RO-based PRACH 808.

FIG. 8B illustrates an RAR transmission scheme 804 for multiple RO-based random access preamble according to some aspects of the present disclosure. The scheme 804 may be substantially similar to the scheme 802. For instance, the BS 105 may detect one or more of the PRACH preamble sequence 410, 412, 414, and 416, but may respond to one of the PRACH preamble sequence 410, 412, 414, and 416. Additionally, the BS 105 may not transmit multiple RAR messages associated with a multiple RO-based random access preamble transmission in the same slot 202 so that the a multiple RO access-based UE 115 may not have to decode multiple PDSCHs in a single slot 202. Referring to the same example discussed above in relation to FIG. 8A, the BS 105 detected the PRACH preamble sequences part 1 410 in the RO 402a (RO0) and the PRACH preamble sequence part 2 412 in the RO 402b (RO1) from the multiple RO-based random access preamble transmission and decided to respond to the PRACH preamble sequence part 1 410. Additionally, the BS 105 detected a random access preamble (e.g., a single RO-based PRACH 808) from a single RO access-based UE 115 in the RO 402b (RO1).

To respond to the PRACH preamble sequence part 1 410, the BS 105 may transmit a first PDCCH 830 in a control portion 342 of a first slot 202a based on a first RA-RNTI (RA-RNTI 720) computed from the RO0. The PDCCH 830 schedules a first RAR message 832 (e.g., MSG2 in a four-step random access and MSGB in a two-step random access) in a data portion 346 of the first slot 202a. The BS 105 transmits the first RAR message 832 in the data portion 346 of the first slot 202a according to the PDCCH 830. The first RAR message 832 may include the PRACH preamble sequence part 1 410 in response to detecting the PRACH preamble sequence part 1 410.

To respond to the single RO-based PRACH 806, the BS 105 may transmit a second PDCCH 840 in a control portion 342 of a second slot 202b based on a second RA-RNTI (RA-RNTI 722) computed from the RO1. In some instances, the second slot 202b may be spaced apart from the first slot 202a as shown. In some other instances, the first slot 202a and the second slot 202b may be consecutive slots 202. The PDCCH 840 schedules a second RAR message 842 (e.g., MSG2 in a four-step random access and MSGB in a two-step random access) in a data portion 346 of the second slot 202b. The BS 105 transmits the second RAR message 842 in the data portion 346 of the second slot 202b according to the PDCCH 840. The second RAR message 842 may include the single RO-based PRACH 806 in response to the single RO-based PRACH 806. Similar to the scheme 804, while the BS 105 also detected the PRACH preamble sequence part 2 412 in the RO1, the BS 105 may not include the PRACH preamble sequence part 2 412 in the second RAR message 842 since the first RAR message 832 already responded to the PRACH preamble sequence part 1 410.

FIG. 8C illustrates an RAR transmission scheme 806 for multiple RO-based random access preamble according to some aspects of the present disclosure. In the scheme 806, the BS 105 may respond to multiple of the PRACH preamble sequence 410, 412, 414, and 416 if they are detected. Referring to the same example discussed above in relation to FIG. 8A, the BS 105 detected the PRACH preamble sequences part 1 410 in the RO 402a (RO0) and the PRACH preamble sequence part 2 412 in the RO 402b (RO1) from the multiple RO-based random access preamble transmission and decided to respond to the PRACH preamble sequence part 1 410. Additionally, the BS 105 detected a random access preamble (e.g., a single RO-based PRACH 808) from a single RO access-based UE 115 in the RO 402b (RO1).

To respond to the PRACH preamble sequence part 1 410, the BS 105 may transmit a first PDCCH 850 in a control portion 342 of a slot 202 based on a first RA-RNTI (RA-RNTI 720) computed from the RO0. The PDCCH 850 schedules a first RAR message 852 (e.g., MSG2 in a four-step random access and MSGB in a two-step random access) in a data portion 346 of the slot 202. The BS 105 transmits the first RAR message 852 in the data portion 346 of the slot 202 according to the PDCCH 850. The first RAR message 852 may include the PRACH preamble sequence part 1 410 in response to detecting the PRACH preamble sequence part 1 410.

To respond to the single RO-based PRACH 806, the BS 105 may transmit a second PDCCH 860 in a control portion 342 of the same slot 202 based on a second RA-RNTI (RA-RNTI 722) computed from the RO1. The PDCCH 860 schedules a second RAR message 862 (e.g., MSG2 in a four-step random access and MSGB in a two-step random access) in a data portion 346 of the slot 202. The BS 105 transmits the second RAR message 862 in the data portion 346 of the slot 202 according to the PDCCH 860. The second RAR message 862 may include the single RO-based PRACH 806 in response to the single RO-based PRACH 806. The second RAR message 862 may also include the PRACH preamble sequence part 2 412 in response to the PRACH preamble sequence part 2 detected in the RO2.

While the UE 115 may detect the first PDCCH 850 based on the first RA-RNTI and the second PDCCH 860 based in the second RA-RNTI, the UE 115 can decode any one of the first RAR message 852 or the second RAR message 862 since the first RAR message 852 and the second RAR message 862 each include a corresponding PRACH preamble sequence 410 or 412, respectively. For instance, if the UE 115 decoded the first RAR message 852 successfully and found the PRACH preamble sequence part 1 410 in the first RAR message 852, the UE 115 may not decode the second RAR message 862 to save processing power or resources. In some other instances, the UE 115 may also receive and decode the second RAR message 862 for a more robust decoding.

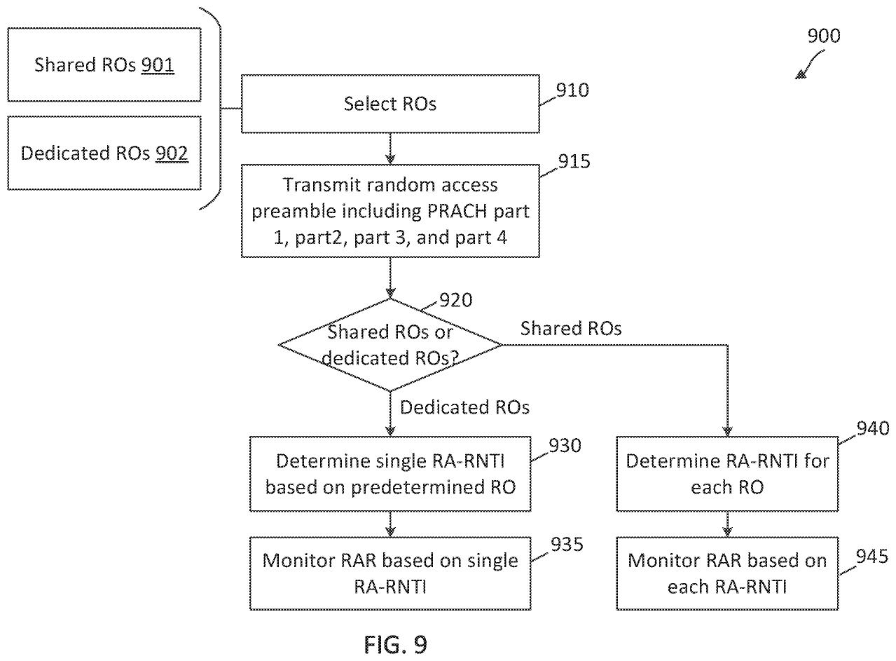

In some aspects, a BS 105 may configure some ROs (e.g., the ROs 901 of FIG. 9) for sharing between a single RO-based random access and a multiple RO-based random access. The BS 105 may also configure some ROs (e.g., the ROs 902 of FIG. 9) dedicated for multiple RO-based random access. In some instances, the BS 105 may configure a first pool of random access preambles for single RO-based random access preamble transmission and a second pool of random access preambles for multiple RO-based random access preamble transmissions. The first pool may include different random access preambles than the second pool. A single RO access-based UE 115 may select a first random access preamble from the first pool and select a single RO from the shared ROs and transmit the first random access preamble in the single RO. A multiple RO access-based UE 115 may select a second random access preamble from the second pool and select multiple ROs from the shared ROs or the dedicated ROs. For instance, the second random access preamble may include PRACH preamble sequences similar to the PRACH preamble sequences 410, 412, 414, and 416. The multiple RO access-based UE 115 may transmit the second random access preamble in the selected multiple ROs. Depending on whether the multiple ROs are selected from the shared ROs or the dedicated ROs, the multiple RO access-based UE 115 may apply the scheme 600 or the scheme 700 to determine RA-RNTI(s) for RAR monitoring as discussed below in FIG. 9.

FIG. 9 is a flow diagram of a random access method 900 according to some aspects of the present disclosure. Aspects of the method 900 can be executed by a computing device (e.g., a processor, processing circuit, and/or other suitable component) of a wireless communication device or other suitable means for performing the steps. For example, a wireless communication device, such as the UEs 115 or 1200 may utilize one or more components, such as the processor 1202, the memory 1204, the random access module 1208, the transceiver 1210, the modem 1212, and the one or more antennas 1216, to execute the steps of method 900. The method 900 may employ similar mechanisms as described above in FIGS. 6-8. As illustrated, the method 900 includes a number of enumerated steps, but aspects of the method 900 may include additional steps before, after, and in between the enumerated steps. In some aspects, one or more of the enumerated steps may be omitted or performed in a different order.

In the method 900, a BS (e.g., the BSs 105) may configure ROs 901 for sharing between single RO-based random access and multiple RO-based random access and may configure ROs 902 dedicated for multiple RO-based random access. The ROs 901 and 902 may be substantially similar to the ROs 302, 402, and/or 502.

At block 910, a UE (e.g., a multiple RO access-based UE 115) selects multiple ROs from the shared ROs 901 or from the dedicated ROs 902. In some instances, the UE may utilize one or more components, such as the processor 1202, the memory 1204, the random access module 1208, the transceiver 1210, the modem 1212, and/or the one or more antennas 1216, to select the multiple ROs. In some instances, the UE may randomly select the multiple ROs from the shared ROs 901 or the dedicated ROs 902. In some instances, the UE may determine whether to select the multiple ROs from the shared ROs 901 or the dedicated ROs 902 based on an earliest upcoming RO. In some instances, the UE may determine whether to select the multiple ROs from the shared ROs 901 or the dedicated ROs 902 based on a processing capability or a pre-configuration of the UE.

At block 915, the UE transmits a random access preamble in the multiple ROs. The random access preamble may include PRACH preamble sequences part 1, part 2, part 3, and part 4 similar to the PRACH preamble sequence 410, 412, 414, and 416, respectively. The UE may transmit each part of the PRACH preamble sequences part 1, part 2, part 3, and part 4 in one of the multiple ROs. In some instances, the UE may utilize one or more components, such as the processor 1202, the memory 1204, the random access module 1208, the transceiver 1210, the modem 1212, and/or the one or more antennas 1216, to transmit the random access preamble in the multiple ROs.

At block 920, the UE determines whether the multiple ROs are selected from the shared ROs 901 or from the dedicated ROs 902. If the multiple ROs are selected from the dedicated ROs 902, the UE proceeds to block 930. In some instances, the UE may utilize one or more components, such as the processor 1202, the memory 1204, the random access module 1208, the transceiver 1210, the modem 1212, and/or the one or more antennas 1216, to determine whether the multiple ROs are selected from the shared ROs 901 or from the dedicated ROs 902.

At block 930, the UE determines a single RA-RNTI for the multiple RO based on a predetermined RO, for example, using the scheme 600 discussed above in relation to FIG. 6. The predetermined RO can be based on a wireless protocol standard such as 3GPP or broadcast by the BS 105. In some instances, the UE may utilize one or more components, such as the processor 1202, the memory 1204, the random access module 1208, the transceiver 1210, the modem 1212, and/or the one or more antennas 1216, to determine the single RA-RNTI.

At block 935, the UE monitors for an RAR message from the BS based on the single RA-RNTI. For example, the UE may monitor for a PDCCH with a CRC masked by the RA-RNTI. If the UE successfully decoded a PDCCH with a CRC masked by the RA-RNTI, the UE decodes the PDSCH scheduled by the PDCCH and obtain the RAR from the decoded PDSCH. In some instances, the UE may utilize one or more components, such as the processor 1202, the memory 1204, the random access module 1208, the transceiver 1210, the modem 1212, and/or the one or more antennas 1216, to monitor for the RAR message based on the single RA-RNTI.

Returning to block 920, if the multiple ROs are selected from the shared ROs 901, the UE proceeds to block 940. At block 940, the UE determines an RA-RNTI (e.g., the RA-RNTIs 720, 722, 724, and 72) for each RO of the multiple RO, for example, using the scheme 700 discussed above in relation to FIG. 7. In some instances, the UE may utilize one or more components, such as the processor 1202, the memory 1204, the random access module 1208, the transceiver 1210, the modem 1212, and/or the one or more antennas 1216, to determine each RA-RNTI for each RO of the multiple ROs.

At block 945, the UE monitors for an RAR message from the BS based on the multiple RA-RNTIs. In some instances, the UE may utilize one or more components, such as the processor 1202, the memory 1204, the random access module 1208, the transceiver 1210, the modem 1212, and/or the one or more antennas 1216, to monitor for the RAR message based on the multiple RA-RNTIs. For instance, the UE may monitor for the RAR message during an RAR window based on at least one of a first RA-RNTI determined for a first RO of the multiple ROs or a second RA-RNTI determined for a second RO of the multiple ROs. In some aspects, the UE may receive a first PDCCH scheduling a first RAR message based on the first RA-RNTI and receive the first RAR message based on the first PDCCH. The first RAR message may include the PRACH preamble sequence part 1 transmitted in the first RO. The UE may also receive a second PDCCH scheduling a second RAR message based on the second RA-RNTI, for example, in the same slot as the first PDCCH or a different slot than the first PDCCH. In some aspects, the UE may also not and receive and decode the second RAR message scheduled by the second PDCCH, for example, based on a successfully decoding of the first RAR message and receiving an RAR for the random access preamble transmission (indicated by the inclusion of the PRACH preamble sequence part 1 in the first RAR message). In some other aspects, the UE may also receive and decode the second RAR message scheduled by the second PDCCH, for example, for more robust decoding.

Accordingly, if the BS 105 detected a multiple RO-based random access preamble from one or more ROs of dedicated ROs 902, the BS 105 may respond to the multiple RO-based random access preamble based on a single RA-RNTI computed from the predetermine RO among the multiple ROs. Alternatively, if the BS 105 detected a multiple RO-based random access preamble from one or more ROs of the shared ROs 901, the BS 105 may respond to the multiple RO-based random access preamble based on an RA-RNTI computed from an RO where a PRACH preamble sequence part is detected.

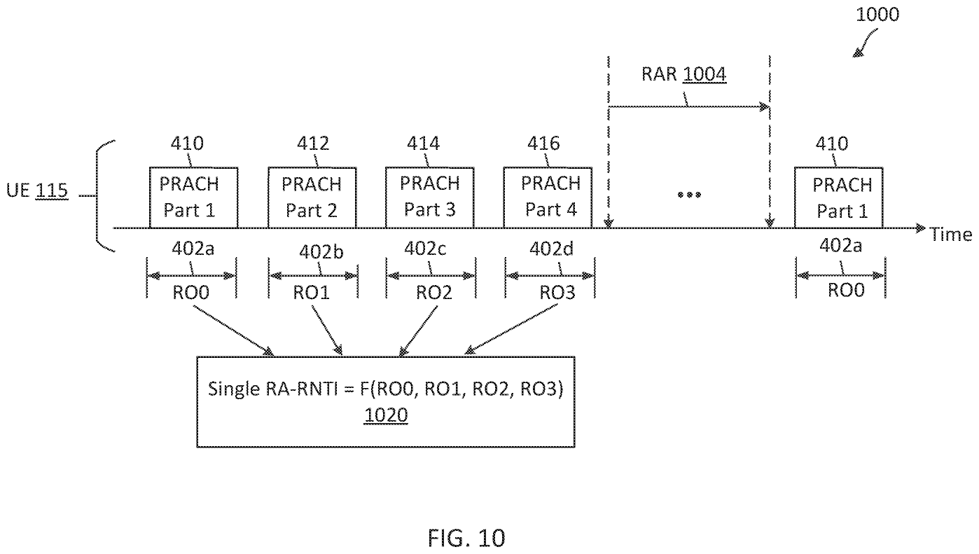

FIG. 10 illustrates a random access preamble transmission scheme 1000 using multiple ROs according to some aspects of the present disclosure. The scheme 1000 may be employed by a UE 115 and a BS 105 in a network such as the network 100 for communication. In some aspects, the BS 105 and the UE 115 may employ the scheme 1000 in conjunction with the method 300. The x-axis represents time in some arbitrary units. The y-axis represents frequency in some arbitrary units. The scheme 1000 is illustrated using the same RO configuration (with multiple ROs in time) and the same random access preamble transmission configuration as the scheme 400 and may use the same reference numerals at FIG. 4 for simplicity's sake. Although the scheme 1000 is illustrated using multiple ROs in time, it should be understood that similar RA-RNTI determination mechanisms can be applied to multiple ROs in frequency as shown in FIG. 5.

Similar to the scheme 600, a BS 105 may indicate a pool of random access preambles and a pool of ROs for random access in a PRACH configuration. However, in the scheme 1000, the UE 115 may determine an RA-RNTI 1020 for the multiple ROs 402 where the UE 115 transmitted the random access preamble using a new formulation, for example, different from equation (1). For instance, the new formulation may be a function of each RO 402 of the multiple ROs 402. The new function can be denoted as F(RO1, RO2, . . . , RO_K), where K is the latest RO in the multiple ROs 402. In the illustrated example of FIG. 10 with 4 ROs 402, the new function can be represented by F(RO0, RO1, RO2, RO3). As an example, the new function may be dependent on a time location (e.g., a starting symbol index and/or a starting slot index) and a frequency location (e.g., an RB index, an RB set index) of each of the RO 402 as shown below:

RA-RNTI=K+Σᵣ₌₀^{R-1}a×t(r)+b×f(r), (2)

where K represents a constant, r represents the RO index, R represents the number of ROs in the multiple ROs 402, t represents timing information associated with the r^{th} RO, f represents frequency information associated with the r^{th} RO, and a and b are scaling factors.

In another example, the new function for computing an RA-RNTI for multiple ROs can be defined as shown below:

RA-RNTI=K2+s_id+14×t_id+14×80×f_id+14×80×8×ul_carrier_id, (3)

where K2 represents a constant, s_id represents the index of the first OFDM symbol of an RO within the multiple ROs (e.g., 0≤s_id<14), t_id represents the index of the first slot symbol of the RO in a system frame (e.g., 0≤t_id<80), f_id represents the index of the RO in the frequency domain (e.g., 0≤s_id<8), and ul_carrier_id represents the UL carrier used for the random access preamble transmission (e.g., 0=normal carrier, 1=supplement UL carrier). The RO may be an earliest RO, a latest RO, or any RO within the multiple ROs. The constant K2 may differentiate an RA-RNTI associated with multiple RO-based random access preamble from an RA-RNTI associated with a single RO-based random access preamble.

Accordingly, the UE 115 may monitor for an RAR (e.g., MSG2 in a four-step random access and MSGB in a two-step random access) in an RAR window 1004 based on the RA-RNTI 1020 determined based on the new function, and the BS 105 may respond to the random access preamble based on the RA-RNTI 1020. For instance, the BS 105 may transmit a PDCCH with a CRC masked by the single RA-RNTI 1020, where the PDCCH may include a schedule for a MSG2 or MSGB for the UE 115, for example, similar to the RAR transmission in the scheme 340 discussed above in relation to FIG. 3C.

In some aspects, the new formulation may be specified by a wireless communication standard such as the 3GPP. In some aspects, the BS 105 may indicate the new formulation, for example, in a PRACH configuration. In some aspects, the BS 105 may also indicate a configuration for an RAR window 1004 which the UE 115 may use for the RAR monitoring. In some aspects, the RAR window 1004 may start after an offset from an earliest RO of the multiple ROs, a latest RO of the multiple RO, or any other RO of the multiple ROs.

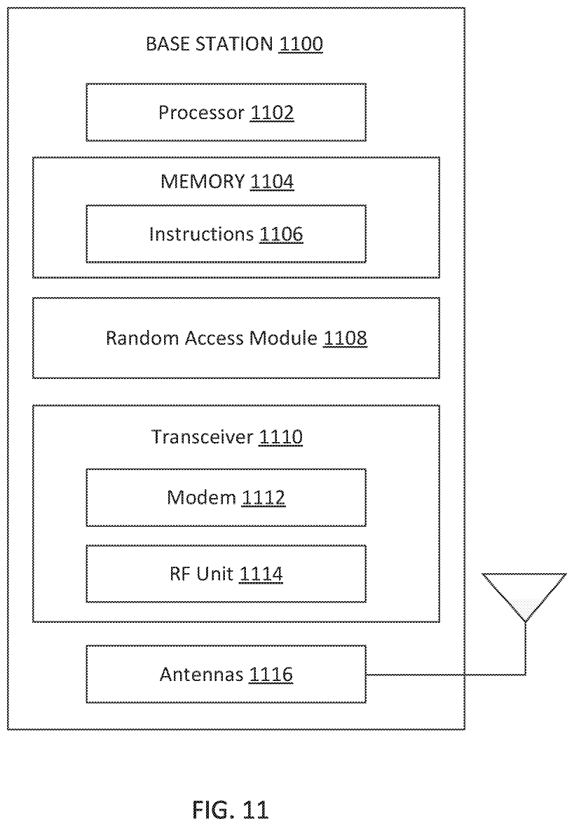

FIG. 11 is a block diagram of an exemplary BS 1100 according to some aspects of the present disclosure. The BS 1100 may be a BS 105 in the network 100 as discussed above in FIG. 1. As shown, the BS 1100 may include a processor 1102, a memory 1104, a random access module 1108, a transceiver 1110 including a modem subsystem 1112 and a RF unit 1114, and one or more antennas 1116. These elements may be in direct or indirect communication with each other, for example via one or more buses.

The processor 1102 may have various features as a specific-type processor. For example, these may include a CPU, a DSP, an ASIC, a controller, a FPGA device, another hardware device, a firmware device, or any combination thereof configured to perform the operations described herein. The processor 1102 may also be implemented as a combination of computing devices, e.g., a combination of a DSP and a microprocessor, a plurality of microprocessors, one or more microprocessors in conjunction with a DSP core, or any other such configuration.

The memory 1104 may include a cache memory (e.g., a cache memory of the processor 1102), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 1104 may include a non-transitory computer-readable medium. The memory 1104 may store instructions 1106. The instructions 1106 may include instructions that, when executed by the processor 1102, cause the processor 1102 to perform operations described herein, for example, aspects of FIGS. 2, 3A-3C, 4-7, 8A-8C, 9-10 and 14. Instructions 1106 may also be referred to as program code. The program code may be for causing a wireless communication device to perform these operations, for example by causing one or more processors (such as processor 1102) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The random access module 1108 may be implemented via hardware, software, or combinations thereof. For example, the random access module 1108 may be implemented as a processor, circuit, and/or instructions 1106 stored in the memory 1104 and executed by the processor 1102. In some examples, the random access module 1108 can be integrated within the modem subsystem 1112. For example, the random access module 1108 can be implemented by a combination of software components (e.g., executed by a DSP or a general processor) and hardware components (e.g., logic gates and circuitry) within the modem subsystem 1112.

The random access module 1108 may be used for various aspects of the present disclosure, for example, aspects of FIGS. 2, 3A-3C, 4-7, 8A-8C, 9-10 and 14. The random access module 1108 is configured to transmit a configuration indicating a random access preamble for a random access associated with multiple ROs, receive from a UE (e.g., the UEs 115 or 1200), the random access preamble in the one or more ROs of the multiple ROs, determine one or more RA-RNTIs for the multiple ROs, and transmit an RAR message (e.g., MSG2 in a four-step random access and MSGB in a two-step random access) based on the one or more determine RA-RNTIs during an RAR window associated with the multiple ROs. In some aspects, the random access preamble may include multiple PRACH preamble sequence sequences similar to the PRACH preamble sequences 410, 412, 414, and 416, which may be multiple repetitions of a preamble sequence or may be different preamble sequences that are linked or in association with each other for multiple RO-based random access.

In some aspects, the random access module 1108 is configured to determine a single RA-RNTI for the multiple ROs based on a predetermine RO among the multiple ROs as shown in the scheme 600 discussed above with reference to FIG. 6. In some aspects, the random access module 1108 is configured to determine an RA-RNTI for each RO of the multiple RO based on each RO as shown in the scheme 700 discussed above with reference to FIG. 7. In some aspects, the random access module 1108 is configured to respond to a multiple RO-based random access preamble as shown in the schemes 802, 804, and 806 discussed above with reference to FIGS. 8A-8C. In some aspects, the random access module 1108 is configured to determine whether to determine a single RA-RNTI for the multiple ROs or determine an RA-RNTI for each RO of the multiple RO based on whether the multiple ROs are associated with multiple RO-based random access or single RO-based random access as shown in the method 900 discussed above with reference to FIG. 9. In some aspects, the random access module 1108 is configured to determine a single RA-RNTI for the multiple ROs based on a function dependent on each RO of the multiple ROs as shown in the scheme 1000 discussed above with reference to FIG. 10.

As shown, the transceiver 1110 may include the modem subsystem 1112 and the RF unit 1114. The transceiver 1110 can be configured to communicate bi-directionally with other devices, such as the UEs 115 and/or another core network element. The modem subsystem 1112 may be configured to modulate and/or encode data according to a MCS, e.g., a LDPC coding scheme, a turbo coding scheme, a convolutional coding scheme, a digital beamforming scheme, etc. The RF unit 1114 may be configured to process (e.g., perform analog to digital conversion or digital to analog conversion, etc.) modulated/encoded data (e.g., RMSI, OSI, SIBs, PRACH configurations, MSG2, MSG4, MSGB) from the modem subsystem 1112 (on outbound transmissions) or of transmissions originating from another source such as a UE 115. The RF unit 1114 may be further configured to perform analog beamforming in conjunction with the digital beamforming. Although shown as integrated together in transceiver 1110, the modem subsystem 1112 and/or the RF unit 1114 may be separate devices that are coupled together at the BS 105 to enable the BS 105 to communicate with other devices.

The RF unit 1114 may provide the modulated and/or processed data, e.g. data packets (or, more generally, data messages that may contain one or more data packets and other information), to the antennas 1116 for transmission to one or more other devices. This may include, for example, transmission of information to complete attachment to a network and communication with a camped UE 115 according to some aspects of the present disclosure. The antennas 1116 may further receive data messages transmitted from other devices and provide the received data messages for processing and/or demodulation at the transceiver 1110. The transceiver 1110 may provide the demodulated and decoded data (e.g., MSG1, multiple RO-based random access preamble, single RO-based random access preamble, MSG3, MSGA) to the random access module 1108 for processing. The antennas 1116 may include multiple antennas of similar or different designs in order to sustain multiple transmission links.

In some aspects, the transceiver 1110 is configured to communicate with components of the BS 1100 to transmit a configuration indicating a random access preamble for a random access associated with multiple ROs, receive, from a UE (e.g., the UEs 115 or 1200), the random access preamble in one or more ROs of the multiple ROs. The processor 1102 is configured to communicate with components of the BS 1100 to determine one or more RA-RNTIs. The transceiver 1110 is configured to communicate with components of the BS 1100 to transmit, in response to the random access preamble in an RAR window associated with the multiple ROs, an RAR message based on the one or more determined RA-RNTIs.

In an aspect, the BS 1100 can include multiple transceivers 1110 implementing different RATs (e.g., NR and LTE). In an aspect, the BS 1100 can include a single transceiver 1110 implementing multiple RATs (e.g., NR and LTE). In an aspect, the transceiver 1110 can include various components, where different combinations of components can implement different RATs.

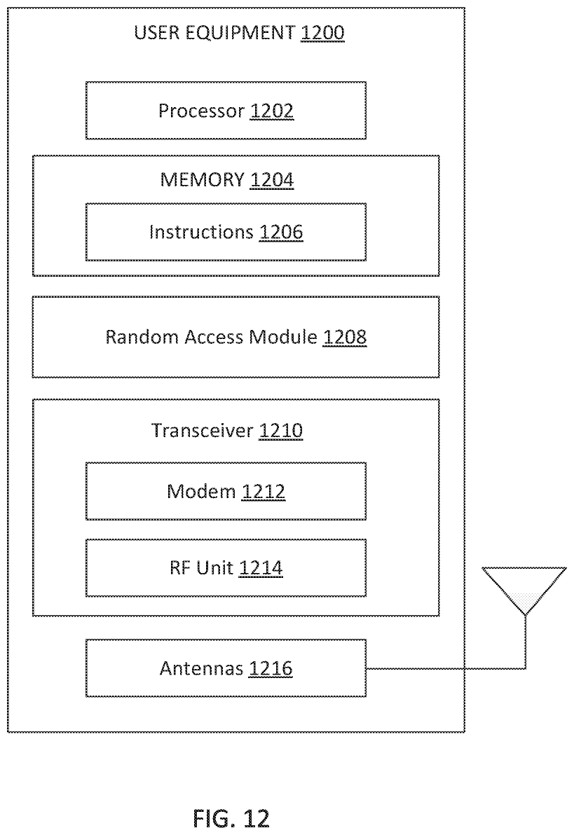

FIG. 12 is a block diagram of an exemplary UE 1200 according to some aspects of the present disclosure. The UE 1200 may be a UE 115 as discussed above with respect to FIG. 1. As shown, the UE 1200 may include a processor 1202, a memory 1204, a random access module 1208, a transceiver 1210 including a modem subsystem 1212 and a radio frequency (RF) unit 1214, and one or more antennas 1216. These elements may be in direct or indirect communication with each other, for example via one or more buses.

The processor 1202 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1202 may also be implemented as a combination of computing devices, e.g., a combination of a DSP and a microprocessor, a plurality of microprocessors, one or more microprocessors in conjunction with a DSP core, or any other such configuration.

The memory 1204 may include a cache memory (e.g., a cache memory of the processor 1202), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 1204 includes a non-transitory computer-readable medium. The memory 1204 may store, or have recorded thereon, instructions 1206. The instructions 1206 may include instructions that, when executed by the processor 1202, cause the processor 1202 to perform the operations described herein with reference to the UEs 115 in connection with aspects of the present disclosure, for example, aspects of FIGS. 2, 3A-3C, 4-7, 8A-8C, 9-10 and 13. Instructions 1206 may also be referred to as program code, which may be interpreted broadly to include any type of computer-readable statement(s) as discussed above with respect to FIG. 11.

The random access module 1208 may be implemented via hardware, software, or combinations thereof. For example, the random access module 1208 may be implemented as a processor, circuit, and/or instructions 1206 stored in the memory 1204 and executed by the processor 1202. In some examples, the random access module 1208 can be integrated within the modem subsystem 1212. For example, the random access module 1208 can be implemented by a combination of software components (e.g., executed by a DSP or a general processor) and hardware components (e.g., logic gates and circuitry) within the modem subsystem 1212.

The random access module 1208 may be used for various aspects of the present disclosure, for example, aspects of FIGS. 2, 3A-3C, 4-7, 8A-8C, 9-10 and 13. The random access module 1208 is configured to receive a configuration indicating a random access preamble for a random access associated with multiple ROs, transmit to a BS (e.g., the BSs 105 or 1100), the random access preamble in the one or more ROs of the multiple ROs, determine one or more RA-RNTIs for the multiple ROs, and monitor for an RAR message (e.g., MSG2 in a four-step random access and MSGB in a two-step random access) based on the one or more determine RA-RNTIs during an RAR window associated with the multiple ROs. In some aspects, the random access preamble may include multiple PRACH preamble sequence sequences similar to the PRACH preamble sequences 410, 412, 414, and 416, which may be multiple repetitions of a preamble sequence or may be different preamble sequences that are linked or in association with each other for multiple RO-based random access.

In some aspects, the random access module 1208 is configured to determine a single RA-RNTI for the multiple ROs based on a predetermine RO among the multiple ROs as shown in the scheme 600 discussed above with reference to FIG. 6. In some aspects, the random access module 1208 is configured to determine a RA-RNTI for each RO of the multiple RO based on each RO as shown in the scheme 700 discussed above with reference to FIG. 7. In some aspects, the random access module 1208 is configured to monitor for the RAR message as shown in the schemes 802, 804, and 806 discussed above with reference to FIGS. 8A-8C. In some aspects, the random access module 1208 is configured to determine whether to determine a single RA-RNTI for the multiple ROs or determine an RA-RNTI for each RO of the multiple RO based on whether the multiple ROs are associated with multiple RO-based random access or single RO-based random access as shown in the method 900 discussed above with reference to FIG. 9. In some aspects, the random access module 1208 is configured to determine a single RA-RNTI for the multiple ROs based on a function dependent on each RO of the multiple ROs as shown in the scheme 1000 discussed above with reference to FIG. 10.

As shown, the transceiver 1210 may include the modem subsystem 1212 and the RF unit 1214. The transceiver 1210 can be configured to communicate bi-directionally with other devices, such as the BSs 105. The modem subsystem 1212 may be configured to modulate and/or encode the data from the memory 1204 and/or the random access module 1208 according to a modulation and coding scheme (MCS), e.g., a low-density parity check (LDPC) coding scheme, a turbo coding scheme, a convolutional coding scheme, a digital beamforming scheme, etc. The RF unit 1214 may be configured to process (e.g., perform analog to digital conversion or digital to analog conversion, etc.) modulated/encoded data (e.g., MSG1, multiple RO-based random access preamble, single RO-based random access preamble, MSG3, MSGA) from the modem subsystem 1212 (on outbound transmissions) or of transmissions originating from another source such as a UE 115 or a BS 105. The RF unit 1214 may be further configured to perform analog beamforming in conjunction with the digital beamforming. Although shown as integrated together in transceiver 1210, the modem subsystem 1212 and the RF unit 1214 may be separate devices that are coupled together at the UE 115 to enable the UE 115 to communicate with other devices.

The RF unit 1214 may provide the modulated and/or processed data, e.g. data packets (or, more generally, data messages that may include one or more data packets and other information), to the antennas 1216 for transmission to one or more other devices. The antennas 1216 may further receive data messages transmitted from other devices. The antennas 1216 may provide the received data messages for processing and/or demodulation at the transceiver 1210. The transceiver 1210 may provide the demodulated and decoded data (e.g., RMSI, OSI, SIBs, PRACH configurations, MSG2, MSG4, MSGB) to the random access module 1208 for processing. The antennas 1216 may include multiple antennas of similar or different designs in order to sustain multiple transmission links. The RF unit 1214 may configure the antennas 1216.

In some aspects, the transceiver 1210 is configured to communicate with components of the UE 1200 to receive a configuration indicating a random access preamble for a random access associated with multiple ROs, transmit the random access preamble in one or more ROs of the multiple ROs. The processor 1202 is configured to communicate with components of the UE 1200 to determine one or more RA-RNTIs for the multiple ROs. The transceiver 1210 is configured to communicate with components of the UE 1200 to monitor, in an RAR window associated with the multiple ROs, for an RAR message based on the one or more determined RA-RNTIs.

In an aspect, the UE 1200 can include multiple transceivers 1210 implementing different RATs (e.g., NR and LTE). In an aspect, the UE 1200 can include a single transceiver 1210 implementing multiple RATs (e.g., NR and LTE). In an aspect, the transceiver 1210 can include various components, where different combinations of components can implement different RATs.

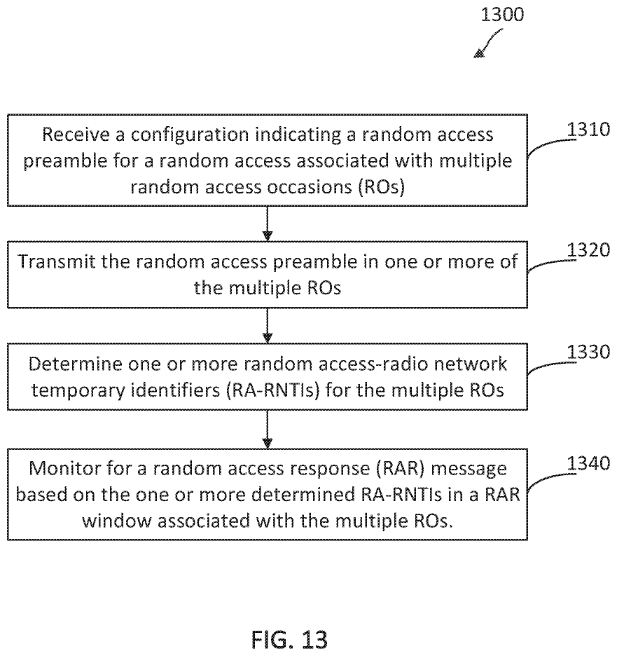

FIG. 13 is a flow diagram of a wireless communication method 1300 according to some aspects of the present disclosure. Aspects of the method 1300 can be executed by a computing device (e.g., a processor, processing circuit, and/or other suitable component) of a wireless communication device or other suitable means for performing the steps. For example, a wireless communication device, such as the UEs 115 or 1200 may utilize one or more components, such as the processor 1202, the memory 1204, the random access module 1208, the transceiver 1210, the modem 1212, and the one or more antennas 1216, to execute the steps of method 1300. The method 1300 may employ similar mechanisms as described above in FIGS. 2, 3A-3C, 4-7, 8A-8C, and 9-10. As illustrated, the method 1300 includes a number of enumerated steps, but aspects of the method 1300 may include additional steps before, after, and in between the enumerated steps. In some aspects, one or more of the enumerated steps may be omitted or performed in a different order.

At block 1310, a UE (e.g., the 115 or 1200) receives a configuration indicating a random access preamble for a random access associated with multiple ROs. In some instances, the UE may utilize one or more components, such as the processor 1202, the memory 1204, the random access module 1208, the transceiver 1210, the modem 1212, and/or the one or more antennas 1216, to receive the configuration indicating the random access preamble for the random access associated with the multiple ROs.

In some aspects, the UE may receive the configuration from a SIB broadcast by a BS (e.g., the BS 105 and/or 1100). In some aspects, the configuration may indicate a random access preamble pool. In some aspects, the random access preamble pool or a portion of the random access preamble pool may configured for exclusive multiple RO-based random access preamble transmissions. The configuration may also indicate ROs associated with the random access preamble pool. In some aspects, each RO of the multiple ROs may include at least one of a different time resource or a different frequency resource.

At block 1320, the UE transmits the random access preamble in one or more of the multiple ROs. For instance, the UE may randomly select the random access preamble from the random access preamble pool or the portion of the random access preamble pool configured for exclusive multiple RO-based random access preamble transmissions. The UE may also randomly select the multiple ROs from the ROs indicated by the configuration. In some instances, the UE may utilize one or more components, such as the processor 1202, the memory 1204, the random access module 1208, the transceiver 1210, the modem 1212, and/or the one or more antennas 1216, to transmit the random access preamble in the one or more of the multiple ROs.

In some aspects, as part of transmitting the random access preamble, the UE may transmitting at least one of a first random access preamble (e.g., PRACH preamble sequence part 1 410) in a first RO of the multiple ROs or a second random access preamble (e.g., PRACH preamble sequence part 2 412) in a second RO of the multiple ROs. In some aspects, as part of transmitting the random access preamble, the UE may transmit the first random access preamble in the first RO and the second random access preamble in the second RO, where the second random access preamble is a least one of a repetition of the first random access preamble or associated with the first random access preamble.

At block 1330, the UE determines one or more RA-RNTIs for the multiple ROs. In some instances, the UE may utilize one or more components, such as the processor 1202, the memory 1204, the random access module 1208, the transceiver 1210, the modem 1212, and/or the one or more antennas 1216, to determine the one or more RA-RNTIs for the multiple ROs.

In some aspects, as part of determining the one or more RA-RNTIs for the multiple ROs, the UE may determine a single RA-RNTI for the multiple ROs based on a predetermined RO among the multiple ROs, for example, as shown in the scheme 600 discussed above with reference to FIG. 6. In some aspects, the configuration received at block 1310 may also indicate the predetermined RO. In some aspects, the UE may determine the single RA-RNTI further based on the multiple ROs being configured for an exclusive multiple RO-based random access, as shown in the method 900 discussed above with reference to FIG. 9.

In some aspects, as part of determining the one or more RA-RNTIs for the multiple ROs, the UE may determine an RA-RNTI for each RO of the multiple ROs. In some aspects, the configuration received at block 1310 may also indicate a rule for determining the RA-RNTI for each RO of the multiple ROs based on each RO. In some aspects, the UE may determine the RA-RNTI for each RO of the multiple ROs further based on one or more of the multiple ROs being configured for sharing between a multiple RO-based random access and a single RO-based random access, as shown in the method 900 discussed above with reference to FIG. 9.

In some aspects, as part of determining the one or more RA-RNTIs for the multiple ROs, the UE may a first RA-RNTI for the multiple ROs based on a function associated with the multiple ROs. For instance, the function may be dependent on a starting symbol index of each RO of the multiple ROs and/or a frequency resource or RB set index of each RO of multiple ROs, for example, as shown in the scheme 1000 discussed above with reference to FIG. 10. In some aspects, the configuration received at block 1310 may also indicate the function associated with the multiple ROs for determining the first RA-RNTI for the multiple ROs.

At block 1340, the UE monitors for an RAR message based on the one or more determined RA-RNTIs in an RAR window associated with the multiple ROs. In some instances, the UE may utilize one or more components, such as the processor 1202, the memory 1204, the random access module 1208, the transceiver 1210, the modem 1212, and/or the one or more antennas 1216, to monitor for the RAR message.

In some aspects, when the UE determines the single RA-RNT based on the predetermined RO at block 1330, the UE may monitor for the RAR message based on the single RA-RNTI. For instance, the UE may monitor for a PDCCH candidate with a CRC masked with the single RA-RNTI, for example, based on blind decoding. If the UE successfully decodes a PDDCH candidate with a CRC masked with the RA-RNTI, the UE may proceed to receive and decode the RAR message scheduled by the PDCCH candidate, for example, as shown in the scheme 340 discussed above with reference to FIG. 3C. When the UE determines the first RA-RNTI based on the multiple ROs at block 1330, the UE may monitor for the RAR using similar mechanisms as shown in the scheme 340 discussed above with reference to FIG. 3C.

In some aspects, when the UE determines an RO for each of the multiple ROs at block 1330, the UE may monitor, for the RAR message during the RAR window, based on at least one of a first RA-RNTI determined for the first RO in response to transmitting the first random access preamble or a second RA-RNTI determined for the second RO in response to transmitting the second random access preamble. In some aspects, as part of the monitoring, the UE may receive a first PDCCH scheduling a first RAR message based on the first RA-RNTI and receive, based on the first PDCCH, the first RAR message including the first random access preamble. In some aspects, the UE may also receive a second PDCCH scheduling a second RAR message based on the second RA-RNTI and receive, based on the second PDCCH, the second RAR message including the second random access preamble, for example, as shown in the scheme 806 discussed above with reference to FIG. 8C. In some aspects, the UE may receive the first RAR message and the second RAR message in the same slot. In some aspects, the UE may receive the first RAR message the second RAR message in different slots, for example, as shown in the scheme 804 discussed above in reference to FIG. 8B. In some aspects, the UE may receiving a second PDCCH scheduling a second RAR message based on the second RA-RNTI and receive, based on the second PDCCH, the second RAR message excluding the second random access preamble, for example, as shown in the scheme 802 discussed above in reference to FIG. 8A.

In some aspects, the UE may further determine a start of the RAR window (e.g., the RAR window 604) for the multiple ROs based on a predetermined RO among the multiple ROs. In some aspects, the configuration received at block 1310 may indicate the predetermined RO to be used for determining the start of the RAR. In some aspects, the predetermined RO corresponds to an earliest RO of the multiple ROs and the UE may determine start the RAR window after the earliest RO.

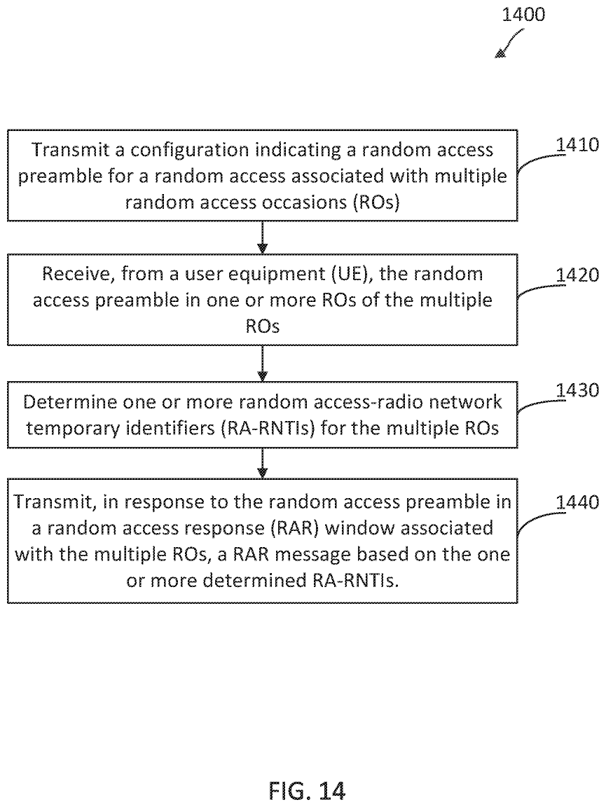

FIG. 14 is a flow diagram of a wireless communication method 1400 according to some aspects of the present disclosure. Aspects of the method 1400 can be executed by a computing device (e.g., a processor, processing circuit, and/or other suitable component) of a wireless communication device or other suitable means for performing the steps. For example, a wireless communication device, such as the BSs 105 or 1100 may utilize one or more components, such as the processor 1102, the memory 1104, the random access module 1108, the transceiver 1110, the modem 1112, and the one or more antennas 1116, to execute the steps of method 1400. The method 1400 may employ similar mechanisms as described above in FIGS. 2, 3A-3C, 4-7, 8A-8C, and 9-10. As illustrated, the method 1400 includes a number of enumerated steps, but aspects of the method 1400 may include additional steps before, after, and in between the enumerated steps. In some aspects, one or more of the enumerated steps may be omitted or performed in a different order.

At block 1410, a BS (e.g., the BS 105 or 1100) transmits a configuration indicating a random access preamble for a random access associated with multiple ROs. In some instances, the BS may utilize one or more components, such as the processor 1102, the memory 1104, the random access module 1108, the transceiver 1110, the modem 1112, and/or the one or more antennas 1116, to transmit the configuration indicating the random access preamble for the random access associated with the multiple ROs.

In some aspects, the BS may broadcast a SIB including the. In some aspects, the configuration may indicate a random access preamble pool. In some aspects, the random access preamble pool or a portion of the random access preamble pool may configured for exclusive multiple RO-based random access preamble transmissions. The configuration may also indicate ROs associated with the random access preamble pool. In some aspects, each RO of the multiple ROs may include at least one of a different time resource or a different frequency resource.

At block 1420, the BS receives, from a UE (e.g., the UEs 115 or 1200), the random access preamble in one or more ROs of the multiple ROs. In some instances, the BS may utilize one or more components, such as the processor 1102, the memory 1104, the random access module 1108, the transceiver 1110, the modem 1112, and/or the one or more antennas 1116, to receive the random access preamble in the one or more ROs of the multiple ROs.

In some aspects, as part of receiving the random access preamble, the BS may receive at least one of a first random access preamble (e.g., PRACH preamble sequence part 1 410) in a first RO of the multiple ROs or a second random access preamble (e.g., PRACH preamble sequence part 2 412) in a second RO of the multiple ROs. In some aspects, as part of receiving the random access preamble, the BS may receive the first random access preamble in the first RO and the second random access preamble in the second RO, where the second random access preamble is a least one of a repetition of the first random access preamble or associated with the first random access preamble.

At block 1430, the BS determines one or more RA-RNTIs for the multiple ROs. In some instances, the BS may utilize one or more components, such as the processor 1102, the memory 1104, the random access module 1108, the transceiver 1110, the modem 1112, and/or the one or more antennas 1116, to determine the one or more RA-RNTs for the multiple ROs.

In some aspects, as part of determining the one or more RA-RNTIs for the multiple ROs, the BS may determine a single RA-RNTI for the multiple ROs based on a predetermined RO among the multiple ROs, for example, as shown in the scheme 600 discussed above with reference to FIG. 6. In some aspects, the configuration transmitted at block 1410 may also indicate the predetermined RO. In some aspects, the BS may determine the single RA-RNTI further based on the multiple ROs being configured for an exclusive multiple RO-based random access, as shown in the method 900 discussed above with reference to FIG. 9.

In some aspects, as part of determining the one or more RA-RNTIs for the multiple ROs, the BS may determine an RA-RNTI for each RO of the multiple ROs. In some aspects, the configuration transmitted at block 1410 may also indicate a rule for determining the RA-RNTI for each RO of the multiple ROs based on each RO. In some aspects, the BS may determine the RA-RNTI for each RO of the multiple ROs further based on one or more of the multiple ROs being configured for sharing between a multiple RO-based random access and a single RO-based random access, as shown in the method 900 discussed above with reference to FIG. 9.

In some aspects, as part of determining the one or more RA-RNTIs for the multiple ROs, the BS may determine a first RA-RNTI for the multiple ROs based on a function associated with the multiple ROs. For instance, the function may be dependent on a starting symbol index of each RO of the multiple ROs and/or a frequency resource or RB set index of each RO of multiple ROs, for example, as shown in the scheme 1000 discussed above with reference to FIG. 10. In some aspects, the configuration transmitted at block 1410 may also indicate the function associated with the multiple ROs for determining the first RA-RNTI for the multiple ROs.

At block 1440, the BS transmits, in response to the random access preamble in an RAR window associated with the multiple ROs, an RAR message based on the one or more determined RA-RNTIs. In some instances, the BS may utilize one or more components, such as the processor 1102, the memory 1104, the random access module 1108, the transceiver 1110, the modem 1112, and/or the one or more antennas 1116, to transmit the RAR message based in the one or more determine RA-RNTIs.

In some aspects, when the BS determines the single RA-RNT based on the predetermined RO at block 1430, the UE may transmit, in response to receiving the at least one of the first random access preamble in the first RO or the second random access preamble in the second RO and based on the single RA-RNTI, a PDCCH scheduling the RAR message, for example, using similar mechanisms as in the scheme 340 discussed above with reference to FIG. 3C.

In some aspects, when the BS determines an RO for each of the multiple ROs at block 1430, the BS may transmit, in response to receiving the first random access preamble in the first RO, a first PDCCH scheduling a first RAR message based on a first RA-RNTI determined for the first RO and transmit, based on the first PDCCH, the first RAR message including the first random access preamble. The BS may also transmit, in response to receiving the second random access preamble in the second RO, a second PDCCH scheduling a second RAR message based on a second RA-RNTI determined for the second RO transmit, based on the second PDCCH, the second RAR message including the second random access preamble, for example, as shown in the scheme 806 discussed above with reference to FIG. 8C. In some aspects, the BS may transmit the first RAR message and the second RAR message in the same slot. In some aspects, the BS may transmit the first RAR message the second RAR message in different slots, for example, as shown in the scheme 804 discussed above in reference to FIG. 8B. In some aspects, when the BS also receives the second random access preamble in the second RO at block 1420 and a single RO access-based random access preamble, the BS may further transmit a second RAR message based on a second RA-RNTI associated with the second RO in a same slot as the first RAR message, where the second RAR message may include the single RO access-based random access preamble, but may exclude the second random access preamble, for example, as shown in the scheme 802 discussed above in reference to FIG. 8A.

In some aspects, the BS may further determine a start of the RAR window (e.g., the RAR window 604) for the multiple ROs based on a predetermined RO among the multiple ROs. In some aspects, the BS may further indicate the predetermined RO among the multiple ROs for determining the start of the RAR window in the configuration transmitted at block 1410. In some aspects, the predetermined RO may correspond to an earliest RO of the multiple ROs.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication performed by a user equipment (UE), the method comprising:
receiving a configuration indicating a random access preamble for a random access associated with multiple random access occasions (ROs);
transmitting the random access preamble in one or more of the multiple ROs;
determining one or more random access-radio network temporary identifiers (RA-RNTIs) for the multiple ROs; and
monitoring for a random access response (RAR) message based on the one or more determined RA-RNTIs in a RAR window associated with the multiple ROs.

2. The method of claim 1, wherein the transmitting the random access preamble comprises:
transmitting at least one of a first random access preamble in a first RO of the multiple ROs or a second random access preamble in a second RO of the multiple ROs.

3. The method of claim 2, wherein the transmitting the random access preamble further comprises:
transmitting the first random access preamble in the first RO and the second random access preamble in the second RO, wherein the second random access preamble is a least one of a repetition of the first random access preamble or associated with the first random access preamble.

4. The method of any of claims 2-3, wherein:
the determining the one or more RA-RNTIs comprises:
determining a single RA-RNTI for the multiple ROs based on a predetermined RO among the multiple ROs; and
the monitoring for the RAR message comprises:
monitoring, based on the single RA-RNTI, for the RAR message.

5. The method of claim 4, wherein the determining the one or more RA-RNTIs further comprises:
determining the single RA-RNTI further based on the multiple ROs being associated with exclusive multiple RO-based random access.

6. The method of claim 4, wherein the receiving the configuration comprises:
receiving the configuration further indicating the predetermined RO for determining the single RA-RNTI for the multiple ROs.

7. The method of any of claims 2-3, wherein the determining the one or more RA-RNTIs comprises:
determining an RA-RNTI for each RO of the multiple ROs.

8. The method of claim 7, wherein the determining the one or more RA-RNTIs further comprises:
determining the RA-RNTI for each RO of the multiple ROs further based on one or more of the multiple ROs being associated with multiple RO-based random access and single RO-based random access.

9. The method of claim 7, wherein the receiving the configuration comprises:
receiving the configuration further indicating a rule for determining the RA-RNTI for each RO of the multiple ROs based on each RO.

10. The method of claim 7, wherein the monitoring for the RAR message comprises:
monitoring, for the RAR message during the RAR window, based on at least one of:
a first RA-RNTI determined for the first RO in response to transmitting the first random access preamble; or
a second RA-RNTI determined for the second RO in response to transmitting the second random access preamble.

11. The method of claim 10, wherein the monitoring for the RAR message comprises:
receiving a first a physical downlink control channel (PDCCH) scheduling a first RAR message based on the first RA-RNTI; and
receiving, based on the first PDCCH, the first RAR message including the first random access preamble.

12. The method of claim 11, wherein the monitoring for the RAR message comprises:
receiving a second PDCCH scheduling a second RAR message based on the second RA-RNTI; and
receiving, based on the second PDCCH, the second RAR message including the second random access preamble.

13. The method of claim 12, wherein the monitoring for the RAR message comprises:
receiving the first RAR message during a first slot; and
receiving the second RAR message during the first slot.

14. The method of claim 12, wherein the monitoring for the RAR message comprises:
receiving the first RAR message during a first slot; and
receiving the second RAR message during a second slot different from the first slot.

15. The method of claim 11, wherein the monitoring for the RAR message comprises:
receiving a second PDCCH scheduling a second RAR message based on the second RA-RNTI; and
receiving, based on the second PDCCH, the second RAR message excluding the second random access preamble.

16. The method of any of claims 1-3, further comprising:
determining a start of the RAR window for the multiple ROs based on a predetermined RO among the multiple ROs.

17. The method of claim 16, wherein the receiving the configuration further comprising:
receiving the configuration further indicating the predetermined RO among the multiple ROs for determining the start of the RAR window.

18. The method of claim 16, wherein the predetermined RO corresponds to an earliest RO of the multiple ROs.

19. The method of claim 1, wherein the determining the one or more RA-RNTIs comprises:
determining a first RA-RNTI for the multiple ROs based on a function associated with the multiple ROs.

20. The method of claim 19, wherein the receiving the configuration further comprises:
receiving the configuration further indicating the function associated with the multiple ROs for determining the first RA-RNTI for the multiple ROs.

21. The method of any of claims 1-3, wherein each RO of the multiple ROs includes a different frequency resource.

22. The method of any of claims 1-3, wherein each RO of the multiple ROs includes a different time resource.

23. A method of wireless communication performed by a base station, the method comprising:
transmitting a configuration indicating a random access preamble for a random access associated with multiple random access occasions (ROs);
receiving, from a user equipment (UE), the random access preamble in one or more ROs of the multiple ROs;
determining one or more random access-radio network temporary identifiers (RA-RNTIs) for the multiple ROs; and
transmitting, in response to the random access preamble in a random access response (RAR) window associated with the multiple ROs, a RAR message based on the one or more determined RA-RNTIs.

24. The method of claim 23, wherein the receiving the random access preamble comprises:
receiving at least one of a first random access preamble in a first RO of the multiple ROs or a second random access preamble in a second RO of the multiple ROs.

25. The method of claim 24, wherein the receiving the random access preamble further comprises:
receiving the first random access preamble in the first RO and the second random access preamble in the second RO, wherein the second random access preamble is a least one of a repetition of the first random access preamble or associated with the first random access preamble.

26. The method of any of claims 24-25, wherein:
the determining the one or more RA-RNTIs comprises:
determining a single RA-RNTI for the multiple ROs based on a predetermined RO among the multiple ROs; and
the transmitting the RAR message comprises:
transmitting, in response to receiving the at least one of the first random access preamble in the first RO or the second random access preamble in the second RO and based on the single RA-RNTI, a physical downlink control channel (PDCCH) scheduling the RAR message.

27. The method of claim 26, wherein the determining the one or more RA-RNTIs further comprises:
determining the single RA-RNTI further based on the multiple ROs being associated with exclusive multiple RO-based random access.

28. The method of claim 26, wherein the transmitting the configuration comprises:
transmitting the configuration further indicating the predetermined RO for determining the single RA-RNTI for the multiple ROs.

29. The method of any of claims 24-25, wherein the determining the one or more RA-RNTIs comprises:
determining an RA-RNTI for each RO of the multiple ROs based on the RO.

30. The method of claim 29, wherein the determining the one or more RA-RNTIs further comprises:
determining the RA-RNTI for each RO of the multiple ROs further based on one or more of the multiple ROs being associated with multiple RO-based random access and single RO-based random access.

31. The method of claim 29, wherein the transmitting the configuration comprises:
transmitting the configuration further indicating a rule for determining the RA-RNTI for each RO of the multiple ROs based on each RO.

32. The method of claim 29, wherein the transmitting the RAR message comprises:
transmitting, in response to receiving the first random access preamble in the first RO, a first a physical downlink control channel (PDCCH) scheduling a first RAR message based on a first RA-RNTI determined for the first RO; and
transmitting, based on the first PDCCH, the first RAR message including the first random access preamble.

33. The method of claim 32, wherein the transmitting the RAR message comprises:
transmitting, in response to receiving the second random access preamble in the second RO, a second PDCCH scheduling a second RAR message based on a second RA-RNTI determined for the second RO; and
transmitting, based on the second PDCCH, the second RAR message including the second random access preamble.

34. The method of claim 33, wherein the transmitting the RAR message comprises:
transmitting the first RAR message during a first slot; and
transmitting the second RAR message during the first slot.

35. The method of claim 33, wherein the transmitting the RAR message comprises:
transmitting the first RAR message during a first slot; and
transmitting the second RAR message during a second slot different from the first slot.

36. The method of claim 32, wherein:
the receiving the at least one of the first random access preamble or the second random access preamble comprises:
receiving, from the UE, the second random access preamble in the second RO; and
the method further comprising:
transmitting a second RAR message based on a second RA-RNTI associated with the second RO in a same slot as the first RAR message, the second RAR message excluding the second random access preamble.

37. The method of any of claims 23-25, further comprising:
determining a start of the RAR window for the multiple ROs based on a predetermined RO among the multiple ROs.

38. The method of claim 37, wherein the transmitting the configuration further comprising:
transmitting the configuration further indicating the predetermined RO among the multiple ROs for determining the start of the RAR window.

39. The method of claim 37, wherein the predetermined RO corresponds to an earliest RO of the multiple ROs.

40. The method of any of claims 23-25, wherein the determining the one or more RA-RNTIs comprises:
determining a first RA-RNTI for the multiple ROs based on a function associated with the multiple ROs.

41. The method of claim 40, wherein the transmitting the configuration further comprises:
transmitting the configuration further indicating the function associated with the multiple ROs for determining the first RA-RNTI for the multiple ROs.

42. The method of any of claims 23-25, wherein each RO of the multiple ROs includes a different frequency resource.

43. The method of any of claims 23-25, wherein each RO of the multiple ROs includes a different time resource.

44. A user equipment (UE) comprising:
a transceiver configured to:
receive a configuration indicating a random access preamble for a random access associated with multiple random access occasions (ROs); and
transmit the random access preamble in one or more of the multiple ROs; and
a processor configured to:
determine one or more random access-radio network temporary identifiers (RA-RNTIs) for the multiple ROs; and
monitor for a random access response (RAR) message based on the one or more determined RA-RNTIs in a RAR window associated with the multiple ROs.

45. The UE of claim 44, wherein the transceiver configured to transmit the random access preamble is further configured to:
transmit at least one of a first random access preamble in a first RO of the multiple ROs or a second random access preamble in a second RO of the multiple ROs.

46. The UE of claim 45, wherein the transceiver configured to transmit the random access preamble is further configured to:
transmit the first random access preamble in the first RO and the second random access preamble in the second RO, wherein the second random access preamble is a least one of a repetition of the first random access preamble or associated with the first random access preamble.

47. The UE of any of claims 45-46, wherein:
the processor configured to determine the one or more RA-RNTIs is configured to:
determine a single RA-RNTI for the multiple ROs based on a predetermined RO among the multiple ROs; and
the processor configured to monitor for the RAR message is configured to:
monitor, based on the single RA-RNTI, for the RAR message.

48. The UE of claim 47, wherein the processor configured to determine the one or more RA-RNTIs is configured to:
determine the single RA-RNTI further based on the multiple ROs being associated with exclusive multiple RO-based random access.

49. The UE of claim 47, wherein the transceiver configured to receive the configuration is configured to:
receive the configuration further indicating the predetermined RO for determining the single RA-RNTI for the multiple ROs.

50. The UE of any of claims 45-46, wherein the processor configured to determine the one or more RA-RNTIs is configured to:
determine an RA-RNTI for each RO of the multiple ROs.

51. The UE of claim 50, wherein the processor configured to determine the one or more RA-RNTIs is configured to:
determine the RA-RNTI for each RO of the multiple ROs further based on one or more of the multiple ROs being associated with multiple RO-based random access and single RO-based random access.

52. The UE of claim 50, wherein the transceiver configured to receive the configuration is configured to:
receive the configuration further indicating a rule for determining the RA-RNTI for each RO of the multiple ROs based on each RO.

53. The UE of claim 50, wherein the processor configured to monitor for the RAR message is configured to:
monitor, for the RAR message during the RAR window, based on at least one of:
a first RA-RNTI determined for the first RO in response to transmitting the first random access preamble; or
a second RA-RNTI determined for the second RO in response to transmitting the second random access preamble.

54. The UE of claim 53, wherein the processor configured to monitor for the RAR message is configured to:
receive a first a physical downlink control channel (PDCCH) scheduling a first RAR message based on the first RA-RNTI; and
receive, based on the first PDCCH, the first RAR message including the first random access preamble.

55. The UE of claim 54, wherein the processor configured to monitor for the RAR message is configured to:
receive a second PDCCH scheduling a second RAR message based on the second RA-RNTI; and
receive, based on the second PDCCH, the second RAR message including the second random access preamble.

56. The UE of claim 55, wherein the processor configured to monitor for the RAR message is configured to:
receive the first RAR message during a first slot; and
receive the second RAR message during the first slot.

57. The UE of claim 55, wherein the processor configured to monitor for the RAR message is configured to:
receive the first RAR message during a first slot; and
receive the second RAR message during a second slot different from the first slot.

58. The UE of claim 54, wherein the processor configured to monitor for the RAR message is configured to:
receive a second PDCCH scheduling a second RAR message based on the second RA-RNTI; and
receive, based on the second PDCCH, the second RAR message excluding the second random access preamble.

59. The UE of any of claims 44-46, wherein the processor is further configured to:
determine a start of the RAR window for the multiple ROs based on a predetermined RO among the multiple ROs.

60. The UE of claim 59, wherein the transceiver configured to receive the configuration is configured to:
receive the configuration further indicating the predetermined RO among the multiple ROs for determining the start of the RAR window.

61. The UE of claim 59, wherein the predetermined RO corresponds to an earliest RO of the multiple ROs.

62. The UE of claim 44, wherein the processor configured to determine the one or more RA-RNTIs is configured to:
determine a first RA-RNTI for the multiple ROs based on a function associated with the multiple ROs.

63. The UE of claim 62, wherein the transceiver configured to receive the configuration is configured to:
receive the configuration further indicating the function associated with the multiple ROs for determining the first RA-RNTI for the multiple ROs.

64. The UE of any of claims 44-46, wherein each RO of the multiple ROs includes a different frequency resource.

65. The UE of any of claims 44-46, wherein each RO of the multiple ROs includes a different time resource.

66. A base station (BS) comprising:
a transceiver configured to:
transmit a configuration indicating a random access preamble for a random access associated with multiple random access occasions (ROs); and
receive, from a user equipment (UE), the random access preamble in one or more ROs of the multiple ROs; and
a processor configured to:
determine one or more random access-radio network temporary identifiers (RA-RNTIs) for the multiple ROs,
wherein the transceiver is further configured to transmit, in response to the random access preamble in a random access response (RAR) window associated with the multiple ROs, a RAR message based on the one or more determined RA-RNTIs.

67. The BS of claim 66, wherein the transceiver configured to receive the random access preamble is configured to:
receive at least one of a first random access preamble in a first RO of the multiple ROs or a second random access preamble in a second RO of the multiple ROs.

68. The BS of claim 67, wherein the transceiver configured to receive the random access preamble is configured to:
receive the first random access preamble in the first RO and the second random access preamble in the second RO, wherein the second random access preamble is a least one of a repetition of the first random access preamble or associated with the first random access preamble.

69. The BS of any of claims 67-68, wherein:
the processor configured to determine the one or more RA-RNTIs is configured to:
determine a single RA-RNTI for the multiple ROs based on a predetermined RO among the multiple ROs; and
the transceiver configured to transmit the RAR message is configured to:
transmit, in response to receiving the at least one of the first random access preamble in the first RO or the second random access preamble in the second RO and based on the single RA-RNTI, a physical downlink control channel (PDCCH) scheduling the RAR message.

70. The BS of claim 69, wherein the processor configured to determine the one or more RA-RNTIs is configured to:
determine the single RA-RNTI further based on the multiple ROs being associated with exclusive multiple RO-based random access.

71. The BS of claim 69, wherein the transceiver configured to transmit the configuration is configured to:
transmit the configuration further indicating the predetermined RO for determining the single RA-RNTI for the multiple ROs.

72. The BS of any of claims 67-68, wherein the processor configured to determine the one or more RA-RNTIs is configured to:
determine an RA-RNTI for each RO of the multiple ROs based on the RO.

73. The BS of claim 72, wherein the processor configured to determine the one or more RA-RNTIs is configured to:
determine the RA-RNTI for each RO of the multiple ROs further based on one or more of the multiple ROs being associated with multiple RO-based random access and single RO-based random access.

74. The BS of claim 72, wherein the transceiver configured to transmit the configuration is configured to:
transmit the configuration further indicating a rule for determining the RA-RNTI for each RO of the multiple ROs based on each RO.

75. The BS of claim 72, wherein the transceiver configured to transmit the RAR message is configured to:
transmit, in response to receiving the first random access preamble in the first RO, a first a physical downlink control channel (PDCCH) scheduling a first RAR message based on a first RA-RNTI determined for the first RO; and
transmit, based on the first PDCCH, the first RAR message including the first random access preamble.

76. The BS of claim 75, wherein the transceiver configured to transmit the RAR message is configured to:
transmit, in response to receiving the second random access preamble in the second RO, a second PDCCH scheduling a second RAR message based on a second RA-RNTI determined for the second RO; and
transmit, based on the second PDCCH, the second RAR message including the second random access preamble.

77. The BS of claim 76, wherein the transceiver configured to transmit the RAR message is configured to:
transmit the first RAR message during a first slot; and
transmit the second RAR message during the first slot.

78. The BS of claim 76, wherein the transceiver configured to transmit the RAR message is configured to:
transmit the first RAR message during a first slot; and
transmit the second RAR message during a second slot different from the first slot.

79. The BS of claim 75, wherein:
the transceiver configured to receive the at least one of the first random access preamble or the second random access preamble is configured to:
receive, from the UE, the second random access preamble in the second RO; and
the transceiver is further configured to:
transmit a second RAR message based on a second RA-RNTI associated with the second RO in a same slot as the first RAR message, the second RAR message excluding the second random access preamble.

80. The BS of any of claims 66-68, wherein the processor is further configured to:
determine a start of the RAR window for the multiple ROs based on a predetermined RO among the multiple ROs.

81. The BS of claim 80, wherein the transceiver configured to transmit the configuration is configured to:
transmit the configuration further indicating the predetermined RO among the multiple ROs for determining the start of the RAR window.

82. The BS of claim 80, wherein the predetermined RO corresponds to an earliest RO of the multiple ROs.

83. The BS of any of claims 66-68, wherein the processor configured to determine the one or more RA-RNTIs is configured to:
determine a first RA-RNTI for the multiple ROs based on a function associated with the multiple ROs.

84. The BS of claim 83, wherein the transceiver configured to transmit the configuration is configured to:
transmit the configuration further indicating the function associated with the multiple ROs for determining the first RA-RNTI for the multiple ROs.

85. The BS of any of claims 66-68, wherein each RO of the multiple ROs includes a different frequency resource.

86. The BS of any of claims 66-68, wherein each RO of the multiple ROs includes a different time resource.

87. A non-transitory computer-readable medium having program code recorded thereon, the program code comprising:
code for causing a user equipment (UE) to receive a configuration indicating a random access preamble for a random access associated with multiple random access occasions (ROs);
code for causing the UE to transmit the random access preamble in one or more of the multiple ROs;
code for causing the UE to determine one or more random access-radio network temporary identifiers (RA-RNTIs) for the multiple ROs; and
code for causing the UE to monitor for a random access response (RAR) message based on the one or more determined RA-RNTIs in a RAR window associated with the multiple ROs.

88. The non-transitory computer-readable medium of claim 87, wherein the code for causing the UE to transmit the random access preamble is further configured to:
transmit at least one of a first random access preamble in a first RO of the multiple ROs or a second random access preamble in a second RO of the multiple ROs.

89. The non-transitory computer-readable medium of claim 88, wherein the code for causing the UE to transmit the random access preamble is further configured to:
transmit the first random access preamble in the first RO and the second random access preamble in the second RO, wherein the second random access preamble is a least one of a repetition of the first random access preamble or associated with the first random access preamble.

90. The non-transitory computer-readable medium of any of claims 88-89, wherein:
the code for causing the UE to determine the one or more RA-RNTIs is configured to:
determine a single RA-RNTI for the multiple ROs based on a predetermined RO among the multiple ROs; and
the code for causing the UE to monitor for the RAR message is configured to:
monitor, based on the single RA-RNTI, for the RAR message.

91. The non-transitory computer-readable medium of claim 90, wherein the code for causing the UE to determine the one or more RA-RNTIs is configured to:
determine the single RA-RNTI further based on the multiple ROs being associated with exclusive multiple RO-based random access.

92. The non-transitory computer-readable medium of claim 90, wherein the code for causing the UE to receive the configuration is configured to:
receive the configuration further indicating the predetermined RO for determining the single RA-RNTI for the multiple ROs.

93. The non-transitory computer-readable medium of any of claims 88-89, wherein the code for causing the UE to determine the one or more RA-RNTIs is configured to:
determine an RA-RNTI for each RO of the multiple ROs.

94. The non-transitory computer-readable medium of claim 93, wherein the code for causing the UE to determine the one or more RA-RNTIs is configured to:
determine the RA-RNTI for each RO of the multiple ROs further based on one or more of the multiple ROs being associated with multiple RO-based random access and single RO-based random access.

95. The non-transitory computer-readable medium of claim 93, wherein the code for causing the UE to receive the configuration is configured to:
receive the configuration further indicating a rule for determining the RA-RNTI for each RO of the multiple ROs based on each RO.

96. The non-transitory computer-readable medium of claim 93, wherein the code for causing the UE to monitor for the RAR message is configured to:
monitor, for the RAR message during the RAR window, based on at least one of:
a first RA-RNTI determined for the first RO in response to transmitting the first random access preamble; or
a second RA-RNTI determined for the second RO in response to transmitting the second random access preamble.

97. The non-transitory computer-readable medium of claim 96, wherein the code for causing the UE to monitor for the RAR message is configured to:
receive a first a physical downlink control channel (PDCCH) scheduling a first RAR message based on the first RA-RNTI; and
receive, based on the first PDCCH, the first RAR message including the first random access preamble.

98. The non-transitory computer-readable medium of claim 97, wherein the code for causing the UE to monitor for the RAR message is configured to:
receive a second PDCCH scheduling a second RAR message based on the second RA-RNTI; and
receive, based on the second PDCCH, the second RAR message including the second random access preamble.

99. The non-transitory computer-readable medium of claim 98, wherein the code for causing the UE to monitor for the RAR message is configured to:
receive the first RAR message during a first slot; and
receive the second RAR message during the first slot.

100. The non-transitory computer-readable medium of claim 98, wherein the code for causing the UE to monitor for the RAR message is configured to:
receive the first RAR message during a first slot; and
receive the second RAR message during a second slot different from the first slot.

101. The non-transitory computer-readable medium of claim 97, wherein the code for causing the UE to monitor for the RAR message is configured to:
receive a second PDCCH scheduling a second RAR message based on the second RA-RNTI; and
receive, based on the second PDCCH, the second RAR message excluding the second random access preamble.

102. The non-transitory computer-readable medium of any of claims 87-89, wherein the program code further comprises:
code for causing the UE to determine a start of the RAR window for the multiple ROs based on a predetermined RO among the multiple ROs.

103. The non-transitory computer-readable medium of claim 102, wherein the code for causing the UE to receive the configuration is configured to:
receive the configuration further indicating the predetermined RO among the multiple ROs for determining the start of the RAR window.

104. The non-transitory computer-readable medium of claim 102, wherein the predetermined RO corresponds to an earliest RO of the multiple ROs.

105. The non-transitory computer-readable medium of claim 87, wherein the code for causing the UE to determine the one or more RA-RNTIs is configured to:
determine a first RA-RNTI for the multiple ROs based on a function associated with the multiple ROs.

106. The non-transitory computer-readable medium of claim 105, wherein the code for causing the UE to receive the configuration is configured to:
receive the configuration further indicating the function associated with the multiple ROs for determining the first RA-RNTI for the multiple ROs.

107. The non-transitory computer-readable medium of any of claims 87-89, wherein each RO of the multiple ROs includes a different frequency resource.

108. The non-transitory computer-readable medium of any of claims 87-89, wherein each RO of the multiple ROs includes a different time resource.

109. A non-transitory computer-readable medium having program code recorded thereon, the program code comprising:
code for causing a base station (BS) to transmit a configuration indicating a random access preamble for a random access associated with multiple random access occasions (ROs);
code for causing the BS to receive, from a user equipment (UE), the random access preamble in one or more ROs of the multiple ROs;
code for causing the BS to determine one or more random access-radio network temporary identifiers (RA-RNTIs) for the multiple ROs; and
code for causing the BS to transmit, in response to the random access preamble in a random access response (RAR) window associated with the multiple ROs, a RAR message based on the one or more determined RA-RNTIs.

110. The non-transitory computer-readable medium of claim 109, wherein the code for causing the BS to receive the random access preamble is configured to:
receive at least one of a first random access preamble in a first RO of the multiple ROs or a second random access preamble in a second RO of the multiple ROs.

111. The non-transitory computer-readable medium of claim 110, wherein the code for causing the BS to receive the random access preamble is configured to:
receive the first random access preamble in the first RO and the second random access preamble in the second RO, wherein the second random access preamble is a least one of a repetition of the first random access preamble or associated with the first random access preamble.

112. The non-transitory computer-readable medium of any of claims 110-111, wherein:
the code for causing the BS to determine the one or more RA-RNTIs is configured to:
determine a single RA-RNTI for the multiple ROs based on a predetermined RO among the multiple ROs; and
the code for causing the BS to transmit the RAR message is configured to:
transmit, in response to receiving the at least one of the first random access preamble in the first RO or the second random access preamble in the second RO and based on the single RA-RNTI, a physical downlink control channel (PDCCH) scheduling the RAR message.

113. The non-transitory computer-readable medium of claim 112, wherein the code for causing the BS to determine the one or more RA-RNTIs is configured to:
determine the single RA-RNTI further based on the multiple ROs being associated with exclusive multiple RO-based random access.

114. The non-transitory computer-readable medium of claim 112, wherein the code for causing the BS to transmit the configuration is configured to:
transmit the configuration further indicating the predetermined RO for determining the single RA-RNTI for the multiple ROs.

115. The non-transitory computer-readable medium of any of claims 110-111, wherein the code for causing the BS to determine the one or more RA-RNTIs is configured to:
determine an RA-RNTI for each RO of the multiple ROs based on the RO.

116. The non-transitory computer-readable medium of claim 115, wherein the code for causing the BS to determine the one or more RA-RNTIs is configured to:
determine the RA-RNTI for each RO of the multiple ROs further based on one or more of the multiple ROs being associated with multiple RO-based random access and single RO-based random access.

117. The non-transitory computer-readable medium of claim 115, wherein the code for causing the BS to transmit the configuration is configured to:
transmit the configuration further indicating a rule for determining the RA-RNTI for each RO of the multiple ROs based on each RO.

118. The non-transitory computer-readable medium of claim 115, wherein the code for causing the BS to transmit the RAR message is configured to:
transmit, in response to receiving the first random access preamble in the first RO, a first a physical downlink control channel (PDCCH) scheduling a first RAR message based on a first RA-RNTI determined for the first RO; and
transmit, based on the first PDCCH, the first RAR message including the first random access preamble.

119. The non-transitory computer-readable medium of claim 118, wherein the code for causing the BS to transmit the RAR message is configured to:
transmit, in response to receiving the second random access preamble in the second RO, a second PDCCH scheduling a second RAR message based on a second RA-RNTI determined for the second RO; and
transmit, based on the second PDCCH, the second RAR message including the second random access preamble.

120. The non-transitory computer-readable medium of claim 119, wherein the code for causing the BS to transmit the RAR message is configured to:
transmit the first RAR message during a first slot; and
transmit the second RAR message during the first slot.

121. The non-transitory computer-readable medium of claim 119, wherein the code for causing the BS to transmit the RAR message is configured to:
transmit the first RAR message during a first slot; and
transmit the second RAR message during a second slot different from the first slot.

122. The non-transitory computer-readable medium of claim 118, wherein:
the code for causing the BS to receive the at least one of the first random access preamble or the second random access preamble is configured to:
receive, from the UE, the second random access preamble in the second RO; and
the program code further comprises:
code for causing the UE to transmit a second RAR message based on a second RA-RNTI associated with the second RO in a same slot as the first RAR message, the second RAR message excluding the second random access preamble.

123. The non-transitory computer-readable medium of any of claims 109-111, wherein the program code further comprises:
code for causing the BS to determine a start of the RAR window for the multiple ROs based on a predetermined RO among the multiple ROs.

124. The non-transitory computer-readable medium of claim 123, wherein the code for causing the BS to transmit the configuration is configured to:
transmit the configuration further indicating the predetermined RO among the multiple ROs for determining the start of the RAR window.

125. The non-transitory computer-readable medium of claim 123, wherein the predetermined RO corresponds to an earliest RO of the multiple ROs.

126. The non-transitory computer-readable medium of any of claims 109-111, wherein the code for causing the BS to determine the one or more RA-RNTIs is configured to:
determine a first RA-RNTI for the multiple ROs based on a function associated with the multiple ROs.

127. The non-transitory computer-readable medium of claim 126, wherein the code for causing the BS to transmit the configuration is configured to:
transmit the configuration further indicating the function associated with the multiple ROs for determining the first RA-RNTI for the multiple ROs.

128. The non-transitory computer-readable medium of any of claims 109-111, wherein each RO of the multiple ROs includes a different frequency resource.

129. The non-transitory computer-readable medium of any of claims 109-111, wherein each RO of the multiple ROs includes a different time resource.

130. A user equipment (UE) comprising:
means for receiving a configuration indicating a random access preamble for a random access associated with multiple random access occasions (ROs);
means for transmitting the random access preamble in one or more of the multiple ROs;
means for determining one or more random access-radio network temporary identifiers (RA-RNTIs) for the multiple ROs; and
means for monitoring for a random access response (RAR) message based on the one or more determined RA-RNTIs in a RAR window associated with the multiple ROs.

131. The UE of claim 130, wherein the means for transmitting the random access preamble is further configured to:
transmit at least one of a first random access preamble in a first RO of the multiple ROs or a second random access preamble in a second RO of the multiple ROs.

132. The UE of claim 131, wherein the means for transmitting the random access preamble is further configured to:
transmit the first random access preamble in the first RO and the second random access preamble in the second RO, wherein the second random access preamble is a least one of a repetition of the first random access preamble or associated with the first random access preamble.

133. The UE of any of claims 131-132, wherein:
the means for determining the one or more RA-RNTIs is configured to:
determine a single RA-RNTI for the multiple ROs based on a predetermined RO among the multiple ROs; and
the means for monitoring for the RAR message is configured to:
monitor, based on the single RA-RNTI, for the RAR message.

134. The UE of claim 133, wherein the means for determining the one or more RA-RNTIs is configured to:
determine the single RA-RNTI further based on the multiple ROs being associated with exclusive multiple RO-based random access.

135. The UE of claim 133, wherein the means for receiving the configuration is configured to:
receive the configuration further indicating the predetermined RO for determining the single RA-RNTI for the multiple ROs.

136. The UE of any of claims 131-132, wherein the means for determining the one or more RA-RNTIs is configured to:
determine an RA-RNTI for each RO of the multiple ROs.

137. The UE of claim 136, wherein the means for determining the one or more RA-RNTIs is configured to:
determine the RA-RNTI for each RO of the multiple ROs further based on one or more of the multiple ROs being associated with multiple RO-based random access and single RO-based random access.

138. The UE of claim 136, wherein the means for receiving the configuration is configured to:
receive the configuration further indicating a rule for determining the RA-RNTI for each RO of the multiple ROs based on each RO.

139. The UE of claim 136, wherein the means for monitoring for the RAR message is configured to:
monitor, for the RAR message during the RAR window, based on at least one of:
a first RA-RNTI determined for the first RO in response to transmitting the first random access preamble; or
a second RA-RNTI determined for the second RO in response to transmitting the second random access preamble.

140. The UE of claim 139, wherein the means for monitoring for the RAR message is configured to:
receive a first a physical downlink control channel (PDCCH) scheduling a first RAR message based on the first RA-RNTI; and
receive, based on the first PDCCH, the first RAR message including the first random access preamble.

141. The UE of claim 140, wherein the means for monitoring for the RAR message is configured to:
receive a second PDCCH scheduling a second RAR message based on the second RA-RNTI; and
receive, based on the second PDCCH, the second RAR message including the second random access preamble.

142. The UE of claim 141, wherein the means for monitoring for the RAR message is configured to:
receive the first RAR message during a first slot; and
receive the second RAR message during the first slot.

143. The UE of claim 141, wherein the means for monitoring for the RAR message is configured to:
receive the first RAR message during a first slot; and
receive the second RAR message during a second slot different from the first slot.

144. The UE of claim 140, wherein the means for monitoring for the RAR message is configured to:
receive a second PDCCH scheduling a second RAR message based on the second RA-RNTI; and
receive, based on the second PDCCH, the second RAR message excluding the second random access preamble.

145. The UE of any of claims 130-132, further comprising:
means for determining a start of the RAR window for the multiple ROs based on a predetermined RO among the multiple ROs.

146. The UE of claim 145, wherein the means for receiving the configuration is configured to:
receive the configuration further indicating the predetermined RO among the multiple ROs for determining the start of the RAR window.

147. The UE of claim 145, wherein the predetermined RO corresponds to an earliest RO of the multiple ROs.

148. The UE of claim 130, wherein the means for determining the one or more RA-RNTIs is configured to:
determine a first RA-RNTI for the multiple ROs based on a function associated with the multiple ROs.

149. The UE of claim 148, wherein the means for receiving the configuration is configured to:
receive the configuration further indicating the function associated with the multiple ROs for determining the first RA-RNTI for the multiple ROs.

150. The UE of any of claims 130-132, wherein each RO of the multiple ROs includes a different frequency resource.

151. The UE of any of claims 130-132, wherein each RO of the multiple ROs includes a different time resource.

152. A base station (BS) comprising:
means for transmitting a configuration indicating a random access preamble for a random access associated with multiple random access occasions (ROs);
means for receiving, from a user equipment (UE), the random access preamble in one or more ROs of the multiple ROs;
means for determining one or more random access-radio network temporary identifiers (RA-RNTIs) for the multiple ROs; and
means for transmitting, in response to the random access preamble in a random access response (RAR) window associated with the multiple ROs, a RAR message based on the one or more determined RA-RNTIs.

153. The BS of claim 152, wherein the means for receiving the random access preamble is configured to:
receive at least one of a first random access preamble in a first RO of the multiple ROs or a second random access preamble in a second RO of the multiple ROs.

154. The BS of claim 153, wherein the means for receiving the random access preamble is configured to:
receive the first random access preamble in the first RO and the second random access preamble in the second RO, wherein the second random access preamble is a least one of a repetition of the first random access preamble or associated with the first random access preamble.

155. The BS of any of claims 153-154, wherein:
the means for determining the one or more RA-RNTIs is configured to:
determine a single RA-RNTI for the multiple ROs based on a predetermined RO among the multiple ROs; and
the means for transmitting the RAR message is configured to:
transmit, in response to receiving the at least one of the first random access preamble in the first RO or the second random access preamble in the second RO and based on the single RA-RNTI, a physical downlink control channel (PDCCH) scheduling the RAR message.

156. The BS of claim 155, wherein the means for determining the one or more RA-RNTIs is configured to:
determine the single RA-RNTI further based on the multiple ROs being associated with exclusive multiple RO-based random access.

157. The BS of claim 155, wherein the means for transmitting the configuration is configured to:
transmit the configuration further indicating the predetermined RO for determining the single RA-RNTI for the multiple ROs.

158. The BS of any of claims 153-154, wherein the means for determining the one or more RA-RNTIs is configured to:
determine an RA-RNTI for each RO of the multiple ROs based on the RO.

159. The BS of claim 158, wherein the means for determining the one or more RA-RNTIs is configured to:
determine the RA-RNTI for each RO of the multiple ROs further based on one or more of the multiple ROs being associated with multiple RO-based random access and single RO-based random access.

160. The BS of claim 158, wherein the means for transmitting the configuration is configured to:
transmit the configuration further indicating a rule for determining the RA-RNTI for each RO of the multiple ROs based on each RO.

161. The BS of claim 158, wherein the means for transmitting the RAR message is configured to:
transmit, in response to receiving the first random access preamble in the first RO, a first a physical downlink control channel (PDCCH) scheduling a first RAR message based on a first RA-RNTI determined for the first RO; and
transmit, based on the first PDCCH, the first RAR message including the first random access preamble.

162. The BS of claim 161, wherein the means for transmitting the RAR message is configured to:
transmit, in response to receiving the second random access preamble in the second RO, a second PDCCH scheduling a second RAR message based on a second RA-RNTI determined for the second RO; and
transmit, based on the second PDCCH, the second RAR message including the second random access preamble.

163. The BS of claim 162, wherein the means for transmitting the RAR message is configured to:
transmit the first RAR message during a first slot; and
transmit the second RAR message during the first slot.

164. The BS of claim 162, wherein the means for transmitting the RAR message is configured to:
transmit the first RAR message during a first slot; and
transmit the second RAR message during a second slot different from the first slot.

165. The BS of claim 161, wherein:
the means for receiving the at least one of the first random access preamble or the second random access preamble is configured to:
receive, from the UE, the second random access preamble in the second RO; and
the BS further comprises:
means for transmitting a second RAR message based on a second RA-RNTI associated with the second RO in a same slot as the first RAR message, the second RAR message excluding the second random access preamble.

166. The BS of any of claims 152-154, further comprising:
means for determining a start of the RAR window for the multiple ROs based on a predetermined RO among the multiple ROs.

167. The BS of claim 166, wherein the means for transmitting the configuration is configured to:
transmit the configuration further indicating the predetermined RO among the multiple ROs for determining the start of the RAR window.

168. The BS of claim 166, wherein the predetermined RO corresponds to an earliest RO of the multiple ROs.

169. The BS of any of claims 152-154, wherein the means for determining the one or more RA-RNTIs is configured to:
determine a first RA-RNTI for the multiple ROs based on a function associated with the multiple ROs.

170. The BS of claim 169, wherein the means for transmitting the configuration is configured to:
transmit the configuration further indicating the function associated with the multiple ROs for determining the first RA-RNTI for the multiple ROs.

171. The BS of any of claims 152-154, wherein each RO of the multiple ROs includes a different frequency resource.

172. The BS of any of claims 152-154, wherein each RO of the multiple ROs includes a different time resource.
